(19) United States
(12) Patent Application Publication
(10) Pub. No.: US 2004/0116297 A1
(43) Pub. Date: Jun. 17, 2004

(54) Use of polyprenol and its derivatives for facilitating growth of plants

(76) Inventor: Seong-Ryong Kwon, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/661,008

(22) Filed: Sep. 11, 2003

Related U.S. Application Data
(63) Continuation-in-part of application No. PCT/KR02/00446, filed on Mar. 14, 2002.

(30) Foreign Application Priority Data
Mar. 14, 2001 (KR) 2001/13077
Sep. 26, 2002 (WO) 02/074081

(51) Int. Cl. A01N 57/00

(52) U.S. Cl. 504/194

(57) ABSTRACT

Disclosed is a plant growth regulator for increasing crop yield comprising a polyprenol as represented by the following formula.

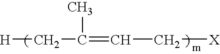

The plant growth regulator for increasing crop yield according to the invention can offer high productivity of crops at lower cost, compared to conventional growth regulators. Further, the plant growth regulator provides a high germination effect of crops and uniformity of plant growth, thereby making it possible to mechanically harvest in an easy manner. Also, it can offer an increasing effect on crop yield in cereals as well as vegetables and fruits, thereby being capable of contributing to agricultural development.

### RELATED APPLICATIONS

This application is a continuation-in-part under 35 U.S.C. § 365(c) claiming the benefit of the filing date of PCT Application No. PCT/KR02/00446 designating the United States, filed Mar. 14, 2002. The PCT Application was published in English as WO 02/074081 A1 on Sep. 26, 2002, and claims the benefit of the earlier filing date of Korean Patent Application No. 2001/13077, filed Mar. 14, 2001. The contents of the Korean Patent Application No. 2001/13077 and the international application No. PCT/KR02/00446 including the publication WO 02/074081 A1 are incorporated herein by reference in their entirety.

### BACKGROUND OF THE INVENTION

1. Field of the Invention

The present invention generally relates to agriculture. More particularly, the present invention relates to facilitating and regulating the growth of plants.

2. Description of the Related Art

Currently, the world's population is increasing by about 100 million a year, while agricultural lands of the world are limited. This situation calls for an efficient use of farmland to ensure maximal production of crops. In Korea, particularly, since the farmland is small, farming should be done intensively. Thus, it is important to produce high quality agricultural products while increasing production per unit area. Meanwhile, by virtue of recent developments in chemical industry, a variety of agrochemicals and fertilizers are manufactured so as to improve agricultural productivity. However, overuse of such chemicals causes problems such as destruction of the ecosystem and environmental pollution, prompting research and development for satisfactory agrochemicals in terms of guarding against toxicity and environmental pollution is required.

Agrochemicals are generally divided into pesticides, fungicides, herbicides and plant growth regulators. The pesticides, fungicides and herbicides are used for preventing a decrease in crop yield. Contrary to the above three types of chemicals, the plant growth regulators serve the purpose of increasing productivity and product quality, by virtue of their diverse physiological activities including ripeness, prevention of fruit drop and reduction of crop lodging as well as increasing of yield of the plants themselves, thus the importance of the plant growth regulator is increasing. The plant growth regulators are varieties of plant hormones, which are substances synthesized in the plants and transported to the appropriate locations where they influence respective tissues and differentiation thereof at extremely low concentrations.

Unlike pesticides, herbicides and fertilizers, plant growth regulators have a characteristic in that they promote or suppress growth and development of the plants. For the regulators, auxins, cytokinins, abscisic acid, ethylene and brassinolides are known. In Korea, water-soluble agent of gibberellins and auxins are currently marketed as a plant growth regulator. The currently marketed plant growth regulators are generally chemically synthesized. Further, the application of regulators is limited to the growth promotion of vegetables and fruits, while there are few cases of the application to cereals. It is another drawback that the regulators are very expensive.

On the other hand, many attempts to develop alternative methods for producing the plant growth regulators have been made. Rice et al. confirmed that tricontanol isolated from alfalfa meal promotes the growth of corn, barley, rice and tomato (Science 195: 1339-1341, 1997). Also, it was reported that tricontanol increased yields of rice by 14.8-41%, depending on the plant breeding, cabbage by 83%, and radish by 108.4% (Cho et al., a research report published by The Ministry of Science and Technology, Korea, “Study on plant growth regulators”, 1983). However, such tricontanol had a drawback of a high production cost. The synthesis method of tricontanol was developed by Rao et al (Organic preparation and procedures, International, 24: 67-70, 1992), but tricontanol produced according to the method is not yet commercially available.

Currently, research on the development of microorganisms for promoting plant growth is ongoing, but the microorganisms do not function in plants as well as chemically synthesized regulators do. Moreover, as part of continuing efforts to increase crop yield, though attempts to develop genetically modified organisms with increased yield using gene cloning technology have been made, those organisms do not show a significant increase in their yield, and their safety is not yet proved, so the organisms are not yet available.

Polyprenols or its derivatives are disclosed in patents and articles. Polyprenols are reported to be useful as pharmaceuticals or synthesis intermediates therefor, particularly as an antiviral agent, as an immunomodulatory agent, as cosmetics and for treating cancer (U.S. Pat. No. 4,668,820 to Ibata, et al., Russian patent number 2005475; L. L. Danilov, et al., Archivum Immunologiae and Thrapiae Experimentalis, 1996, 44, 395-400; A. V. Sanin, et al. Abstracts of the meeting “Dolichols and Related Lipids”, Aug. 11-13, 1993, Zakopane, Poland; European Patent Application 0 350 801; Japanese Patent Application Laid-open No. 62-169724). In U.S. Pat. No. 4,613,593, phosphates of dolichol, a polyprenol isolated from swine liver, are stated to be useful in regenerating liver tissue, and in treating hyperuricuria, hyperlipemia, diabetes, and hepatic diseases in general. R. W. Keenan et al. state that it is important for organisms which rapidly keep growing, for example, those in the infant stage, to take dolichols extraneously so as to supplement the dolichols obtained by biosynthesis within their own body [Archives of Biochemistry and Biophysics, 179, 634 (1977)].

Dolichol was first isolated in 1960 from the human kidney and such animal organs as ox kidney, pig kidney, pig heart, pig liver and rat liver by J. F. Pennock et al [see Nature (London), 186, 470 (1960)]. Later, it was elucidated that dolichol is a mixture of polyprenol homologs having 16 and 22 isoprene units [R. W. Keenan et al., Biochemical Journal, 165, 405 (1977)]. It is also known that dolichol is widely distributed in mammals, and performs a very important function in sustaining the lives of organisms. For example, J. B. Harford et al. demonstrated by in vitro tests using the calf or pig brain white matter that exogenous dolichol enhances incorporation of carbohydrates such as mannose into lipid, and consequently increases the formation of glycoproteins which are important for maintaining the lives of organisms [Biochemical and Biophysical Research Communications, 76, 1036 (1977)]. Since the effect of dolichol to incorporate carbohydrates into lipid is remarkable in mature animals as compared with those in the actively growing stage, the action of dolichol has attracted attention for its possible retarding or prevention of aging. However, the above disclosures teach that these polyprenols or derivatives thereof are useful as medicine and cosmetics.

Regarding a process for producing a polyprenol, it has been known that polyprenol compounds can be extracted from various plants or synthesized by chemical method. With regard to extraction method, K. Hannus et al. reported that a polyisoprenyl fraction in an amount of about 1% dry weight was isolated from the needles of Pinus sylvestris, and the fraction consisted of polyisoprenyl acetates with 10 to 19 isoprene units predominantly in the cis-configuration. However, the polyprenol fraction contains homologs having 15 and 16 isoprene units as major components, and only traces of homologs with 17, 18 and 19 isoprene units which are the main components of mammalian dolichols. Phytochemistry, 13, 2563 (1974). D. F. Zinkel et al. reported that the extracts of Pinus strobus needles contain a C₉₀ polyprenol containing 18 isoprene units or a homologous series of polyprenols averaging 18 units. Phytochemistry, 11, 3387 (1972). U.S. Pat. No. 5,077,046, U.S. Pat. No. 5,012,018 and U.S. Pat. No. 4,886,904 to Tanaka, et al. disclose preparation method for a mixture of polyprenyl homologs with 14 to 22 isoprene units which can be extracted from Ginkgo biloba or Cedrus deodara.

That is, the polyprenyl homologs can be prepared by extracting the leaves of Ginkgo biloba or Cedrus deodara with an oil-soluble organic solvent; if required, hydrolyzing the extract with alkali metal hydroxide such as sodium hydroxide or potassium hydroxide; and subjecting the extract to one or more of chromatography, fractional dissolution, fractional refrigerating precipitation and molecular distillation, thereby separating and recovering a fraction having a specified Rf value in silica thin-layer chromatography. U.S. Pat. No. 4,668,820 to Ibata, et al. discloses preparation method of polyprenols or esters thereof, which are similar to the method described in the above referenced Tanaka, et al.'s patents. Polyprenols or esters thereof with 13 to 21 isoprene units are obtained from the leaves of plants belonging to the genus Pinus L. of the family Pinaceae by extraction, if necessary followed by hydrolysis, esterification or transesterification or a combination thereof. U.S. Pat. No. 4,791,105 to Yamatsa, et al. discloses polyprenol derivatives with 15 to 25 isoprene units. U.S. Pat. No. 4,564,477 to Takigawa, et al. discloses polyprenols and derivatives thereof with 15 to 24 isoprene units.

With regard to chemical synthesis, an all trans-form polyprenol is obtained by; (A) subjecting a 3,7-dimethyl-6-hydroxy-7-octen-1-ol derivative to five-carbon lengthening reaction m-times which comprises reacting with 2-methyl-3,3-dimethoxy-1-butene and reducing the carbonyl group of the resulting compound, to obtain an allyl alcohol derivative; (B) halogenating the hydroxyl group of the allyl alcohol derivative to convert it to form an allyl halide derivative; (C) allowing the allyl halide derivative to react with a polyisoprenyl sulfone derivative to form a sulfonated polyprenol derivative; and (D) subjecting the sulfonated polyprenol derivative to desulfonylation to obtain the all trans-form polyprenol (U.S. Pat. No. 5,714,645 to Asanuma, et al.). U.S. Pat. No. 5,981,811 to Ujita, et al. disclose a process for preparing a polyprenol selectively and in industrially useful yields by dehalogenating a terminal allyl halide, thereby forming a carbon-carbon double bond at a selected position.

Despite the above all disclosures, there is no description or suggestion concerning a use for polyprenol or derivatives thereof as plant growth regulator. And, there is currently a need for improved preparation method compared to known method.

### SUMMARY OF THE INVENTION

The present inventors have conducted studies to develop a plant growth regulator and found that polyprenol facilitates growth of plants, resulting in faster germination, higher yield and growth of crops and so forth.

One aspect of the present invention provides a composition comprising: water; an emulsifier; at least one compound represented by Formula I:

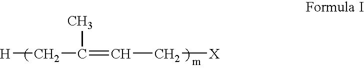

In Formula I, “m” is an integer from about 3 to about 33; from about 8 to about 23; or 10 to about 18. “X” is a substituent group, which may be selected from the group consisting of: (a) hydroxyl and acetyloxy; (b) halo; (c) formyl, mono-fluoroacetyloxy, trifluoroacetyloxy, monochloroacetyloxy, propionyloxy, butyryloxy, stearoyloxy, benzoyloxy, 3,5-dimethylbenzoyloxy, and 4-ethylbenzoyloxy; (d) methoxy, ethoxy, phenoxy, 2-pyridyloxy, 2-benzothiazolyloxy, 2-benzoxazolyloxy, trimethylsilyloxy, dimethyl t-butylsilyloxy, methylthio, ethylthio, phenylthio, tolylthio, 2-thiazolinylthio, 2-benzothiazolylthio, 2-benzoxazolylthio, and 2-pyridylthio; (e) dimethylphosphonoxy, diethylphosphonoxy, and diphenylphosphonoxy; (f) methylsulfinyl, ethylsulfinyl, propylsulfinyl, phenylsulfinyl, and 4-tolylsulfinyl; (g) methylsulfonyl, ethylsulfonyl, propylsulfonyl, phenylsulfonyl, and 4-tolylsulfonyl; (h) methoxycarbonyloxy, ethoxycarbonyloxy, propoxycarbonyloxy, phenoxycarbonyloxy, and 4-tolyloxycarbonyloxy; (i) N,N-dimethylcarbamoyloxy, N,N-diethylcarbamoyloxy, N,N-dipropylcarbamoyloxy, N,N-diphenylcarbamoyloxy, and N-phenyl-N-ethylcarbamoyloxy; (j) trimethylammonium bromide, triethylammonium iodide and diphenylethylammonium bromide; (k) dimethylsulfonium bromide, diethylsulfonium iodide, dipropylsulfonium bromide, and phenylethylsulfonium bromide; and (l) monophosphate, diphosphate, and triphosphate. The compound has a concentration from about 0.01 ppm to about 1000 ppm.

The emulsifier comprises one or more selected from the group consisting octylphenol, polyoxyethylene, polyethyleneglycol fatty acid esters, ethylene glycol fatty acid esters, glycerol fatty acid esters, sucrose fatty acid esters, propylene glycol fatty acid esters, and sorbitan fatty acid or sorbitan fatty acid ester. The compound has a concentration from about 1 ppm to about 100 ppm.

Another aspect of the present invention provides a composition comprising: water; an emulsifier; at least one compound represented by Formula II:

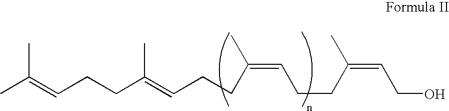

In Formula II, “n” is an integer from 0 to about 30; from about 5 to about 20; or from about 7 to about 15. The compound is undecaprenol or dodecaprenol.

Another aspect of the present invention provides a method of treating a plant. The method comprises: providing a plant; and contacting the plant or a portion thereof with at least one compound represented by the above-defined Formula I. The portion of the plant contacted with the compound is one or more selected from the group consisting of a seed, a shoot, a root, a leaf, a bulb, a fruit, a stem, a trunk, a stalk, a cane, a flower, a flower bud and a surface of the foregoings. The plant is selected from the group consisting of vegetable or fruit plants, grain plants and ornamental plants. The vegetable or fruit plants are selected from the group consisting of tobacco, grape, strawberry, tomato, bell tomato, cucumber, potato, radish, cabbage, bean sprout, red pepper and spinach; wherein the grain plants are selected from the group consisting of rice, barley, corn, millet, bean and wheat; and wherein the ornamental plants are selected from the group consisting of chrysanthemum, rose, lily and gerbera. The compound is contacted with the plant or a portion thereof in the form of liquid. The compound is contacted with the plant or a portion thereof in the form of powder.

In the above-described method, the compound is contacted with the plant or a portion thereof along with a non-Formula I substance. The non-Formula I substance comprises at least one of an emulsifier and water. The emulsifier comprises one or more selected from the group consisting octylphenol, polyoxyethylene, polyethyleneglycol fatty acid esters, ethylene glycol fatty acid esters, glycerol fatty acid esters, sucrose fatty acid esters, propylene glycol fatty acid esters, and sorbitan fatty acid or sorbitan fatty acid ester. The compound contacting the plant or a portion thereof has a concentration from about 0.01 ppm to about 1000 ppm. The compound contacting the plant or a portion thereof has a concentration from about 1 ppm to about 100 ppm. The compound is contacted with the plant or a portion thereof by sprinkling liquid or powder comprising the compound over the plant or the portion thereof. The compound is contacted with the plant or a portion thereof by immersing at least a portion of the plant in a liquid comprising the compound. The compound is contacted with the plant or a portion thereof by injecting a composition comprising the compound into the plant or the portion thereof.

Further, the above-described method comprises cutting at least a portion of the plant so as to contact the compound with an interior of the plant. The method further comprises peeling a skin of the plant or a portion thereof so as to directly contact the compound with an interior of the plant. The plant or a portion thereof is contacted with the compound one or more times. The plant or a portion thereof is contacted with the compound sporadically. The plant or a portion thereof is contacted with the compound periodically. The method further comprises maintaining the plant or a portion thereof in a condition sufficient to grow the plant. The method further comprises harvesting the plant or a portion thereof.

Another aspect of the present invention provides a grown plant from the plant or the portion treated by the above-described method. The portion of the plant is one or more selected from the group consisting of a seed, a shoot, a root, a leaf, a bulb, a fruit, a stem, a trunk, a stalk, a cane, a flower, a flower bud and a surface of the foregoings, and wherein the plant or the portion comprises a scientifically traceable amount of compound.

Still another aspect of the present invention provides a method of treating a plant. The method comprises: providing a plant; and contacting the plant or a portion thereof with at least one compound represented by the above-described Formula II. In the method, the compound contacting with the plant or the portion thereof comprises one or more different forms thereof, and wherein the different forms of the compound have different “n”. The plant is selected from the group consisting of vegetable or fruit plants, grain plants and ornamental plants.

Still another aspect of the present invention provides a plant treated with a chemical compound. The plant comprising: a body of a plant, the body comprising an outer surface; and at least one compound of the above-described Formula I on the outer surface. The plant body is one or more selected from the group consisting of a seed, a shoot, a root, a leaf, a bulb, a fruit, a stem, a trunk, a stalk, a cane, a flower and a flower bud. The plant is selected from the group consisting of vegetable or fruit plants, grain plants and ornamental plants. The vegetable or fruit plants are selected from the group consisting of tobacco, grape, strawberry, tomato, bell tomato, cucumber, potato, radish, cabbage, bean sprout, red pepper and spinach; wherein the grain plants are selected from the group consisting of rice, barley, corn, millet, bean and wheat; and wherein the ornamental plants are selected from the group consisting of chrysanthemum, rose, lily and gerbera. The compound is on the outer surface along with at least one non-Formula I substance. The non-Formula I substance comprises at least one of an emulsifier and water. The compound on the outer surface is in a scientifically traceable amount. The compound is in an amount from about 0.001 μg/cm² to about 100 μg/cm². The compound is in an amount from about 0.0 μg/cm² to about 1.01 μg/cm².

Still another aspect of the present invention provides a method of producing the chemical-compound-treated plant. The method comprises: providing the plant body comprising the outer surface; and contacting the outer surface with at least one of the compounds of the above-described Formula 1. The compound is contacted with the plant body in the form of liquid. The compound is contacted with the plant body in the form of powder. The compound is contacted with the plant body along with at least one non-Formula I substance. The non-Formula I substance comprises at least one of an emulsifier and water. The compound contacting the plant body has a concentration from about 0.01 ppm to about 1000 ppm. The compound contacting the plant body has a concentration from about 1 ppm to about 100 ppm. The compound is contacted with the plant body by sprinkling liquid or powder comprising the compound over the plant body. The compound is contacted with the plant body by immersing at least part of the plant body in a liquid comprising the compound. The plant body is contacted with the compound one or more times during a life thereof. The plant body is contacted with the compound sporadically or periodically. The method further comprises maintaining the plant body in a condition sufficient to grow the plant.

A further aspect of the present invention provides a polyprenol treated plant. The plant comprises: a body of a plant, the body comprising an outer surface; and polyprenol on the outer surface. The polyprenol is represented by the above-described Formula II. The polyprenol comprises one or more different forms thereof, and wherein the different forms of the polyprenol have different “n”. The plant body is one or more selected from the group consisting of a seed, a shoot, a root, a leaf, a bulb, a fruit, a stem, a trunk, a stalk, a cane, a flower and a flower bud.

A still further aspect of the present invention provides a plant growth regulator for increasing crop yield of a plant. The regulator comprises a compound represented by the above-described Formula II. The plant is selected from the group consisting of vegetable or fruit plants, cereal plants, and flowing plants. The vegetable or fruit plants are selected from the group consisting of tobacco, grape, strawberry, tomato, bell tomato, cucumber, potato, radish, cabbage, bean sprout, red pepper and spinach; wherein the cereal plants are selected from the group consisting of rice, barley, corn, millet, bean and wheat; and wherein flowering plants are selected from the group consisting of chrysanthemum, rose, lily and gerbera. The plant growth regulator further comprises an emulsifier. The emulsifier comprises one or more selected from the group consisting octylphenol, polyoxyethylene, polyethyleneglycol fatty acid esters, ethylene glycol fatty acid esters, glycerol fatty acid esters, sucrose fatty acid esters, propylene glycol fatty acid esters, and sorbitan fatty acid or sorbitan fatty acid ester.

A still further aspect of the present invention provides a method of growing a plant. The method comprises: providing a plant; and applying the above-described plant growth regulator to a seed of a plant or a body of a plant. The plant growth regulator is applied by immersing the seed in a liquid comprising the plant growth regulator. The plant growth regulator is applied by spraying the plant growth regulator onto the seed of the plant or the plant body. The plant body is one or more selected from the group consisting of a shoot, a root, a leaf, a bulb, a fruit, a stem, a trunk, a stalk, a cane, a flower and a flower bud. The plant growth regulator is applied with a concentration of the compound at from about 0.01 ppm to about 1000 ppm.

A still further aspect of the present invention provides a method of obtaining polyprenol. The method comprises: providing part of a plant; mixing the plant part with an organic solvent; extracting organic substances from the plant part into the organic solvent, the organic substances comprising a polyprenol derivative; and transforming the derivative to the polyprenol in the presence of a base and a reducing agent. The reducing agent comprises pyrogallol. The derivative is acetylated polyprenol. The step of transforming comprises hydrolyzing the acetylated polyprenol. The method further comprises isolating the polyprenol. The polyprenol comprises one or more different forms having different numbers of a repeated unit thereof. The method further comprises powdering the isolated polyprenol. The plant is selected from the group consisting of a cotton plant, a horse chestnut plant, a tobacco plant, a lords and ladies plant, a silver birch plant, a gingko plant and a soybean plant. The organic solvent is selected from the group consisting of ethanol, methanol, benzene and a mixture of one or more of the foregoings.

### BRIEF DESCRIPTION OF THE DRAWINGS

The above features and other advantages of the present invention will be more clearly understood from the following detailed description taken in conjunction with the accompanying drawings, in which:

FIG. 1 is a chromatogram of HPLC for an extract obtained from leaves of a cotton plant;

FIG. 2 is a mass spectrum of undecaprenol in an extract obtained from leaves of a cotton plant, which is determined using an HPLC-mass spectrometer;

FIG. 3 is a mass spectrum of dodecaprenol in an extract obtained from leaves of a cotton plant, which is determined using an HPLC-mass spectrometer;

FIG. 4 is a ¹H-NMR spectrum of an extract obtained from leaves of a cotton plant; and,

FIG. 5 is a ¹³C-NMR spectrum of an extract obtained from leaves of a cotton plant.

### DETAILED DESCRIPTION OF THE EMBODIMENTS

Polyprenols are a polymers of isoprenoids or isoprene. Some polyprenols are natural compounds and playing diverse biochemical roles. It is known that such polyprenols serve as constituents for quinones in electron transport systems, cell membranes of microorganisms, pigments of photosynthetic systems, such as carotenoids and chlorophylls, and hormones such as gibberellins and brassinosteroids (Taniguchi et al., Proc. Natl. Acad. Sci. USA, 97:131712-131717, 2000). Further, polyprenols have characteristics in that they are very soluble in organic solvents such as ethanol, chloroform, hexane and acetone, and are non-toxic. Also they can be stored for a long period of 6 to 12 months (Stone et al., Biochem. J., 102: 325-330, 1967).

In accordance with one embodiment of the present invention, chemical compounds for use in treating plants are represented by Formula I.

### Formula I

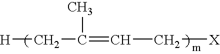

For the sake of convenience, the compounds of Formula I may be referred to as polyprenol(s) or derivatives thereof throughout the specification. Polyprenols refer to the compounds of Formula I where X is —OH. Derivatives of polyprenol(s) refer to compounds of Formula I where X is not —OH. In Formula I, “m” represents an integer equal to or higher than 3. For example, “m” is 3, 4, 5, 6, 7, 8, 9, 10, 11, 12, 13, 14, 15, 16, 17, 18, 19, 20, 21, 22, 23, 24, 25, 26, 27, 28, 29 or 30. Optionally, “m” is an integer from 8 to 23, from 10 to 18. The compound of Formua I is optionally, undecaprenol (m=11) or dodecaprenol (m=12), or their derivatives.

“X” represents a substituent group or radical, preferably a leaving group, which one of ordinary skill in the relevant art would appreciate. The substituent group or radical is broadly defined below and optionally selected from the group including: (a) hydroxyl and acetyloxy; (b) halo; (c) formyl, mono-fluoroacetyloxy, trifluoroacetyloxy, monochloroacetyloxy, propionyloxy, butyryloxy, stearoyloxy, benzoyloxy, 3,5-dimethylbenzoyloxy, and 4-ethylbenzoyloxy; (d) methoxy, ethoxy, phenoxy, 2-pyridyloxy, 2-benzothiazolyloxy, 2-benzoxazolyloxy, trimethylsilyloxy, dimethyl t-butylsilyloxy, methylthio, ethylthio, phenylthio, tolylthio, 2-thiazolinylthio, 2-benzothiazolylthio, 2-benzoxazolylthio, and 2-pyridylthio; (e) dimethylphosphonoxy, diethylphosphonoxy, and diphenylphosphonoxy; (i) methylsulfinyl, ethylsulfinyl, propylsulfinyl, phenylsulfinyl, and 4-tolylsulfinyl; (g) methylsulfonyl, ethylsulfonyl, propylsulfonyl, phenylsulfonyl, and 4-tolylsulfonyl; (h) methoxycarbonyloxy, ethoxycarbonyloxy, propoxycarbonyloxy, phenoxycarbonyloxy, and 4-tolyloxycarbonyloxy; (i) N,N-dimethylcarbamoyloxy, N,N-diethylcarbamoyloxy, N,N-dipropylcarbamoyloxy, N,N-diphenylcarbamoyloxy, and N-phenyl-N-ethylcarbamoyloxy; (j) trimethylammonium bromide, triethylammonium iodide and diphenylethylammonium bromide; (k) dimethylsulfonium bromide, diethylsulfonium iodide, dipropylsulfonium bromide, and phenylethylsulfonium bromide; and (l) monophosphate, diphosphate, and triphosphate.

The isoprene unit within the first parentheses of Formula I could be either trans- or cis— configuration. A single compound of Formula I may include both trans- and cis-configurations of the isoprene unit in a random order. Alternatively, a single compound of Formula I may include a block of either of the trans- and cis-configurations. Optionally, a compound has more trans-units in the left side of the structure of Formula I while having more cis-units in the right side thereof.

In one embodiment of the present invention, the compound of Formula I is undecaprenol, dodecaprenol, derivatives thereof or a mixture thereof. An exemplary of the polyprenols of Formula I is represented by Formula II.

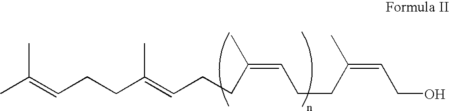

In Formula II, “n” equals to zero or a positive integer. Although not limited thereto, “n” is 0, 1, 2, 3, 4, 5, 6, 7, 8, 9, 10, 11, 12, 13, 14, 15, 16, 17, 18, 19, 20, 21, 22, 23, 24, 25, 26 or 27 in the polyprenol. Optionally, “n” is from about 5 to about 25, from about 7 to about 20.

In an embodiment of the present invention, a compound of Formula I or II or a composition containing one or more compounds of Formula I or II, as a plant growth facilitator or regulator, may be applied to any plants and any part of the plants' body. The body of the plants includes for example, seeds, shoots, roots, leaves, bulbs, stems, trunks, stalks, canes, leaves, flowers, flower buds, and so forth. The plants may be perennial or non-perennial and includes, for example, vegetable plants, fruit plants, grain plants and ornamental plants. Examples of the vegetable or fruit plants include, but not limited thereto, tobacco, grape, strawberry, tomato, bell tomato, cucumber, potato, radish, cabbage, bean sprout, red pepper and spinach. The grain or cereal plants include, for example, rice, barley, millet, corn, bean and wheat. The ornamental plants are any shrubs, trees or flowering plants that can be used for ornamental purposes. For example, flowering plants include chrysanthemum, rose, lily and gerbera. Preferably, the plant growth material is used to rice, wheat, corn, bell tomato, bean, radish, spinach, red pepper, gerbera and cucumber were applied with the plant growth regulator.

In one embodiment, the plant growth facilitator or regulator may be formulated in various ways. One way of formulation is to produce the plant growth facilitator in a form readily applicable to plants. One example is a solution of one or more compounds of Formula I or II dissolved in an appropriate solvent. If the compound(s) is not easily miscible with the solvent, a surfactant or an emulsifier may be added. Water is preferable as the solvent. In the case where plant parts, for example seeds, are immersed in the solution, the concentration of the compound(s) in the readily applicable formulation is determined, for example, such that about 0.01 mg to about 1 g of the compound(s) is effectively contacting 1 kg of plant parts. The concentration of about 0.01 mg to about 1,000 mg per 1 kg of plant parts is translated to 0.01 ppm to about 1000 ppm. Optionally, the concentration is from about 1 ppm to about 100 ppm, or 0.1 ppm to about 50 ppm. In the case where the solution is sprayed over the plant parts such as leaves or stems, the concentration of the compound(s) in the readily applicable formulation is determined, for example, such that about 1 g to about 5,000 g of the compound(s) is effectively sprayed over 1 ha of an area. Optionally, about 10 g to about 1,000 g, or about 50 g to about 500 g of the compound(s) may be sprayed over the 1 ha area.

Another way of formulation is to provide a concentrated form of the plant growth facilitator, which can be diluted with an appropriate medium before application to plants. Concentrated formulations include, for example, a soluble concentrate (SL), an emulsifiable concentrate (EC), a wettable soluble powder (WSP), etc. Preferably, SL and EC are used. The concentration of the compound(s) in the concentrated formulations ranges from about 0.01 wt % to about 80 wt %. The concentration of the compound(s) is, for example, from about 30 to about 70 wt %, preferably about 50 wt % in the soluble concentrate (SL) form; from about 1 wt % to about 10 wt %, preferably 3 wt % in the emulsifiable concentrate (EC) form; and from about 0.1 wt % to about 0.5 wt %, preferably 0.3 wt % in the wettable soluble powder (WSP) form.

In one embodiment the plant growth facilitator or regulator may further include one or more of the compounds including octylphenol, polyoxyethylene, poly (ethylene glycol) fatty acid esters, ethylene glycol fatty acid esters, glycerol fatty acid esters, sucrose fatty acid esters, propylene glycol fatty acid esters, and sorbitan fatty acid or sorbitan fatty acid ester.

In one embodiment, the plant growth regulator or facilitator may be used in combination with one or more functional materials including nutrients, fertilizers and/or pesticides, herbicides, fungicides, insecticides, etc.

In an embodiment, a plant body or a seed is treated with the plant growth regulator comprising a compound of Formula I or II. The plant seed may be immersed in the plant growth regulator, or the plant or seed thereof may be sprayed with the plant growth regulator. Alternatively, the plant growth regulator can be applied by foliage treatment upon cultivating the plant. Such an application of the plant growth regulator by immersing the seed or directly spraying to the plant can save labor expenses. Also, the treatment of seeds, and the treatment of newly emerged stems and leaves (shoots) of the plant with the plant growth regulator can promote and equalize plant growth, making it possible to mechanically harvest in an easy manner.

The plant growth regulator for increasing crop yield is applied at a concentration of the compound(s) of Formula I or II from about 0.01 ppm to about 1000 ppm, and preferably, at a concentration of 1 ppm to 100 ppm.

Polyprenols or derivatives thereof used as the plant growth regulator can be prepared using a chemical synthesis method known in the art, but an extraction method from plants is preferable.

As for the extraction method, plants such as cotton (Gossypium hirsutum L), horse chestnut (Aesculus turbinat), tobacco (ex. Nicotiana tabacum), lords and ladies (ex. Arisema japonicum Blume), silver birch (ex. Betula platyphylla), gingko (ex. Ginkgo biloba), Cedrus deodara (ex. Hymalaya cedar), Pinus sylvestris, soybean (ex. Glycine max) etc. are available. The leaves of these plants are used as the raw materials. Preferably, cotton leaves are used. Since cotton leaves are cheaply available, undecaprenol or dodecaprenol from cotton leaves is preferably employed.

The leaves of plants may range from young green leaves to completely yellowed leaves, and the fallen leaves may also be used. The leaves to be treated by the process may be used undried or after drying. Generally, the dried leaves are preferred. The degree of drying of the leaves should advantageously correspond to an water content, based on the weight of the dried leaves, of less than about 30%, preferably less than about 10%. Preferably, the leaves are extracted after they have been crushed. This increases the area of contact with the extracting solvent, and results in an increased efficiency of extraction.

The polyprenyl homologs of polyprenol are contained in fairly high concentrations generally in the form of a free alcohol and/or acetic acid ester. In order to extract the polyprenyl homologs from the leaves of these plants effectively, the use of oil-soluble organic solvents capable of well dissolving the polyprenyl homologs is convenient.

Suitable oil-soluble organic solvents that can be used have a dielectric constant (ε) of not more than 32.7. Specifically, solvents exemplified below are used either singly or as a mixture of two or more. Petroleum ether, pentane, hexane, heptane, benzene, toluene and xylene, chloroform, methylene chloride, carbon tetrachloride, tetrachloroethane, perchloroethylene and trichloroethylene, methyl acetate, ethyl acetate and ethyl propionate, diethyl ether, diisopropyl ether, tetrahydrofuran and dioxane, acetone, methyl ethyl ketone diethyl ketone and diisopropyl ketone, methyl alcohol, ethyl alcohol, propyl alcohol, and butyl alcohol. The solvent should desirably extract the desired polyprenyl compounds of Formula I selectively with a high efficiency, while permitting minimization of extraction of other substances. From this standpoint, methanol, ethanol or benzene is preferable.

The amount of the extracting solvent is not critical, and can be varied widely depending upon the type of the solvent, the type or condition of the leaves to be extracted, etc. Generally, it is advantageous that the solvent is used in an amount of about 1 to about 100 parts by weight, preferably 5 to 50 parts by weight, more preferably 10 to 30 parts by weight, per part (based on the dry weight) of the leaves of plants.

The extraction can be carried out by dipping the leaves in the solvent, and if required, stirring the solvent continuously or intermittently. The temperature during the extraction is neither critical, and can be varied widely depending upon the extracting conditions such as the type or amount of the solvent used. Generally, the extracting temperature is from about 0° C. to the refluxing temperature of the solvent. Usually, room temperature suffices. Advantageously, under these conditions, the extraction can be carried out for a period of 1 to 10 days.

After the extracting treatment, the leaves and other solid components are removed from the dipping solution and if required, the solvent is removed to form concentrate. The extract is subjected to a separating step consisting of one or more of chromatography, fractional dissolution, fractional refrigerating precipitation and molecular distillation, whereby the desired polyprenyl fraction is recovered.

Polyprenols found in plants exist in an ester form conjugated with acetic acid, or other functionalized forms. To convert these functionalized forms to the alcohol form thereof, acid or base hydrolysis is needed. In the base hydrolysis, a reducing agent such as lithium aluminum hydrides, boron hydrides or pyrogallol is added to the organic substances along with a base, for example, potassium hydroxide solution, whereby the functionalized forms of polyprenols better convert to their alcoholic form.

The extraction method of polyprenol according to one embodiment of the invention comprises a step of removing and drying the organic solvent from the above solution. For drying the organic solvent, anhydrous neutral salts such as anhydrous sodium sulfate and anhydrous magnesium sulfate may be employed. Anhydrous sodium sulfate is preferable.

The extraction method of polyprenol according to one embodiment of the invention comprises a step of concentrating the organic phase after drying and purifying polyprenol therefrom. As for the purification, a method known in the art such as liquid chromatography, and silica gel, Sephadex and LH-20 chromatography may be used. Particularly, thin layer chromatography (TLC) is preferable. Upon performing the chromatography, common solvent mixtures may be employed as mobile solvents. Hexane, hexane/ethyl acetate mixture, and hexane/acetone mixture are preferable.

The extraction method of polyprenol may further comprise a step of powdering the purified polyprenol. For the powdering, a common method known in the art may be used. For the details of the extraction of polyprenols, U.S. Pat. No. 5,077,046, U.S. Pat. No. 5,012,018 and U.S. Pat. No. 4,886,904 to Tanaka, et al., U.S. Pat. No. 4,668,820 to Ibata, et al., U.S. Pat. No. 4,791,105 to Yamatsa, et al., U.S. Pat. No. 4,564,477 to Takigawa etc.) are incorporated herein by reference in their entirety.

To determine whether or not the purified product is polyprenol, a method known in the art may be used. In the examples, particularly, HPLC, NMR, MASS spectrometry and IR spectroscopic analyses were performed. Polyprenol extracted from a plant, particularly, the cotton plant, is undecaprenol (m=11 or n=8) or dodecaprenol (m=12 or n=9).

On the other hand, polyprenol compounds can be also prepared by chemical synthesis. Ujita Katuji in U.S. Pat. No. 5,981,811 reported that to provide a process for preparing a polyprenol in which the number of isoprene unit is small, selectively and industrially advantageously by dehalogenating a terminal allyl halide, thereby constituting a carbon-carbon double bond at a selected position. U.S. Pat. No. 5,981,811 is incorporated herein by reference in its entirety.

The derivatives of polyprenol(s) can be prepared as follows. The polyprenyl halide can easily be produced by halogenating a polyprenol of the Formula I or II, which can be obtained, as mentioned above, from various plants extracts either directly or via hydrolsis, with a halogenating agent such as a phosphorus trihalide (e.g. PCl₃, PBr₃) or a thionyl halide (e.g. SOCl₂, SOBr₂). The halogenation reaction is generally carried out by dissolving the above polyprenol in an appropriate solvent such as, for example, hexane or diethyl ether, and adding thereto the haolgenating agent at about −20° C. to +50° C. in the presence or absence of a base, typically triethylamine or pyridine, for instance. Also, the α-terminal hydroxyl group can be substituted by OMs, OTs, etc. respectively. For example, the following reaction can be done.

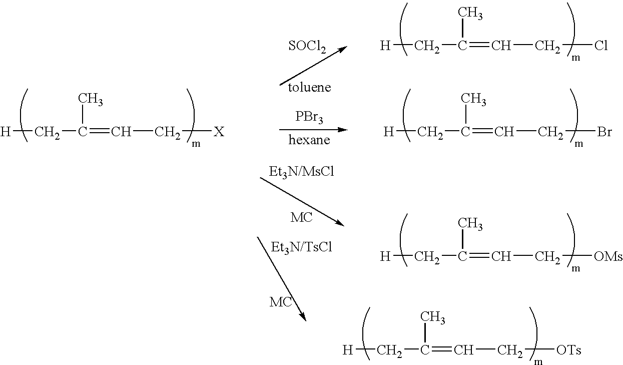

And, continuously the following reaction can be done.

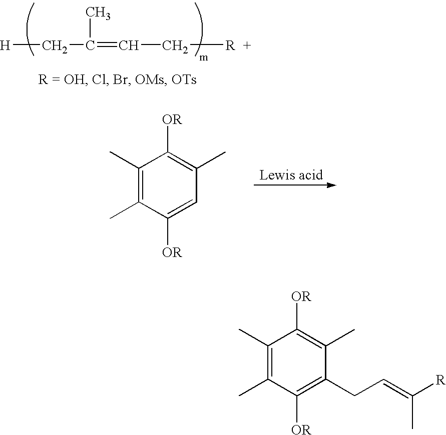

Lewis acid: BF₃.OEt₂, ZnCl₂, AlCl₃, TiCl₄, etc

And, another reaction can be done as follows.

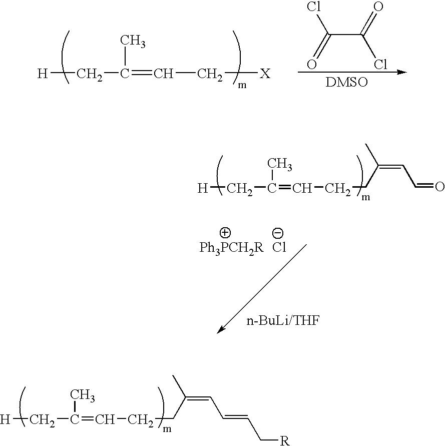

On the other hand, polyprenols (n=6-21 in Formula II or m=9-24 in Formula I) and the derivatives of thereof can be prepared by extraction or synthesis as described in U.S. Pat. No. 4,886,904. In the U.S. Pat. No. 4,886,904, it is described that polyprenol compounds can be extracted from various plants, and so far, solanesol, ficaprenols, betulaprenols have been successfully extracted. The betulaprenols have a structure similar to the dolichols in that two trans-isoprene units are connected to the omega-terminal isoprene unit and a cis-isoprene unit is linked to these trans-isoprene units. However, the betulaprenols so far known contain up to six cis-isoprene units at most. In converting the polyprenols into various derivatives thereof, it may be reacted with a reagent for introduction of a saturated isoprene unit, either as such or after X in Formula II has been replaced by another reactive leaving atom or group.

The substituent group represented by X in Formula II is, for example, selected from the following atoms or groups: (a) hydroxyl and acetyloxy group; (b) halogen atoms such as chlorine, bromine or iodine atom; (c) groups of the formula —OCOR₁, such as formyl, mono-fluoroacetyloxy, trifluoroacetyloxy, monochloroacetyloxy, propionyloxy, butyryloxy, stearoyloxy, benzoyloxy, 3,5-dimethylbenzoyloxy, and 4-ethylbenzoyloxy; (d) groups of the formula —OR₂ such as methoxy, ethoxy, phenoxy, 2-pyridyloxy, 2-benzothiazolyloxy, 2-benzoxazolyloxy, trimethylsilyloxy, dimethyl t-butylsilyloxy, methylthio, ethylthio, phenylthio, tolylthio, 2-thiazolinylthio, 2-benzothiazolylthio, 2-benzoxazolylthio, and 2-pyridylthio; (e) groups of the formula —OPO(OR₃)₂ such as dimethylphosphonoxy, diethylphosphonoxy, and diphenylphosphonoxy; (f) Groups of the formula —SOR₃ such as methylsulfinyl, ethylsulfinyl, propylsulfinyl, phenylsulfinyl and 4-tolylsulfinyl; (g) Groups of the formula —SO₂R₃ such as methylsulfonyl, ethylsulfonyl, propylsulfonyl, phenylsulfonyl, and 4-tolylsulfonyl; (h) Groups of the formula —OCO₂R₃ such as methoxycarbonyloxy, ethoxycarbonyloxy, propoxycarbonyloxy, phenoxycarbonyloxy, and 4-tolyloxycarbonyloxy; (i) Groups of the formula

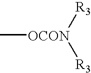

such as N,N-dimethylcarbamoyloxy, N,N-diethylcarbamoyloxy, N,N-dipropylcarbamoyloxy, N,N-diphenylcarbamoyloxy, and N-phenyl-N-ethylcarbamoyloxy; (j) groups of the formula

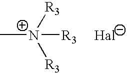

such as trimethylammonium bromide, triethylammonium iodide and diphenylethylammonium bromide; (k) groups of the formula

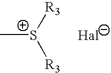

such as dimethylsulfonium bromide, diethylsulfonium iodide, dipropylsulfonium bromide, and phenylethylsulfonium bromide. In these examples, R₁, R₂ and R₃ are the same or different aliphatic or aromatic organic moieties, for example, branched or linear alkyl or aryl groups.

Examples of the polyprenol derivatives are as follow: polyprenyl acetate, polyprenyl bromide, polyprenyl chloride, polyprenyl formate, polyprenyl trifluoroacetate, polyprenyl monochloroacetate, polyprenyl propionate, polyprenyl oleate, polyprenyl stearate, polyprenyl benzoate, polyprenyl methyl ether, polyprenyl phenyl ether, polyprenyl 2-pyridyl ether, polyprenyl 2-benzothiazolyl ether, polyprenyl t-butyldimethylsilyl ether, polyprenyl methyl sulfide, polyprenyl phenyl sulfide, polyprenyl 2-thiazolinyl sulfide, polyprenyl 2-pyridyl sulfide, polyprenyl diethyl phosphate, polyprenyl phenyl sulfoxide, polyprenyl phenyl sulfone, polyprenyl ethyl carbonate, polyprenyl dimethyl carbamate, polyprenyl triethyl ammonium bromide, polyprenyl dimethyl sulfonium bromide, etc. U.S. Pat. No. 4,886,904 and EP 0 873982 are incorporated herein by reference in their entirety.

In an embodiment of the invention, yields of the plant treated with the plant growth regulator comprising polyprenol and the untreated plant control were compared. In the light of the comparison results, it could be seen that where the plant growth regulator comprising polyprenol was applied to the crops, germination was increased by 7 to 40%, crop yield by 10 to 70%, an above-the ground part of the crops (stems and leaves) by 2 to 40%, and a subterranean part of the crops (roots) by 7 to 90%.

The various aspects and features of the present invention will be further illustrated by the following examples, which are not intended to limit the scope of the invention.

### EXAMPLES

### Example 1

### Isolation of an Extract Containing Polyprenol From the Plant Leaves

10 g of dried leaves of the cotton plant were treated with 100 ml ethanol and 100 ml benzene to extract organic solvent-soluble substances. This step was performed three times. The organic solvents were evaporated off to yield a concentrated product. The concentrated organic solvent-soluble substances were added with a 90 ml 50% potassium hydroxide solution containing 200 mg pyrogallol, and with an equivalent volume of benzene, followed by stirring at room temperature for 1 hr. The solution was diluted with distilled water. The benzene layer was removed using a separatory funnel, washed with distilled water and dried over anhydrous Na₂SO₄. The extract was concentrated using a rotary evaporator (Buchi R-205).

### Example 2

### Purification of Polyprenol from the Extract

To purify the extract isolated in Example 1 into a product with a purity of more than 90%, thin layer chromatography using hexane, a mixture of hexane ethyl acetate, and a mixture of hexane and acetone as mobile solvents was performed.

As for the mobile solvents, hexane was first used, then a mixture of hexane and ethyl acetate, then a mixture of hexane and acetone were used. After development, the color fixing reagent containing iodine and a mixed solution of p-anisaldehyde, methanol, acetic acid and H₂SO₄ (mixing ratio 0.5:85:10:5) was treated. The development pattern was confirmed using an UV lamp (long wavelength 365 nm; short wavelength 264 nm). In this way, fractions containing polyprenol were identified. For the fractions, UV absorbance was measured and a UV profile thereof was obtained. The fractions having the same absorbance were pooled and stored at a low temperature in the dark.

Thereafter, to confirm whether the above substance was polyprenol, a series of analyses using high performance liquid chromatography (HPLC), mass spectrometry, NMR spectroscopy and Infra-red (IR) spectroscopy were performed to identify the chemical structure thereof.

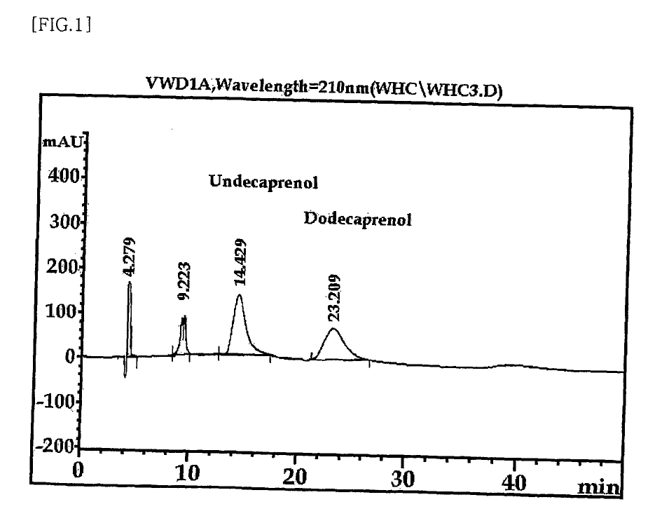

First, the substance was quantified using HPLC (Waters alliance system; column, μ-Bondapak 3.8×300 mm; mobile phase, 100% acetonitrile; flow rate, 2.5 ml/min). The result is shown in FIG. 1.

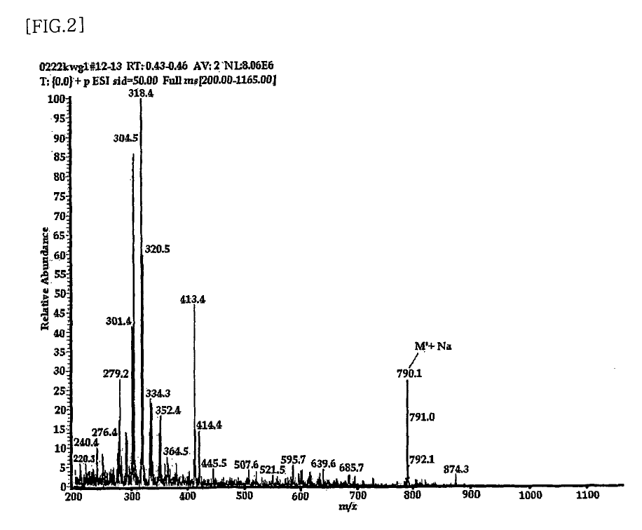

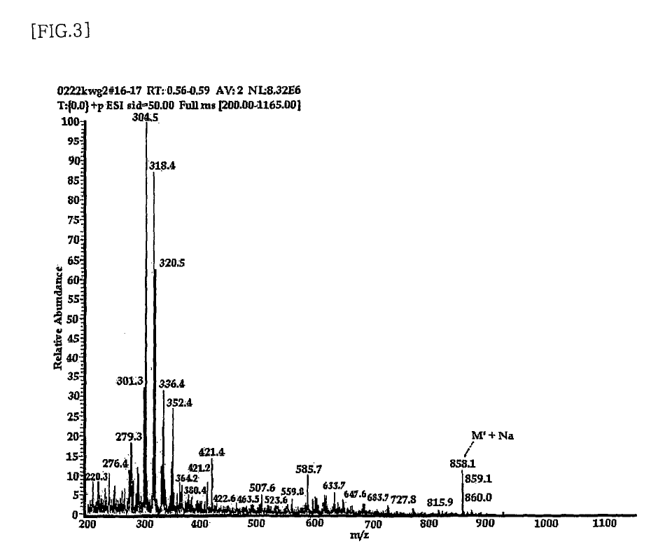

Based on the above result, a mass analysis was performed using a liquid chromatography-mass spectrometer (VG BIOTECH platform; ion source, ESI; resolution, 1000; mass range, 2-3000 (m/z). The result is shown in FIG. 2 and FIG. 3.

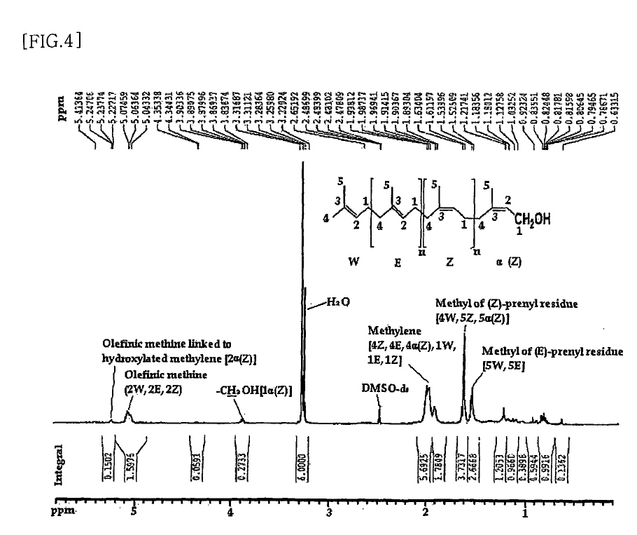

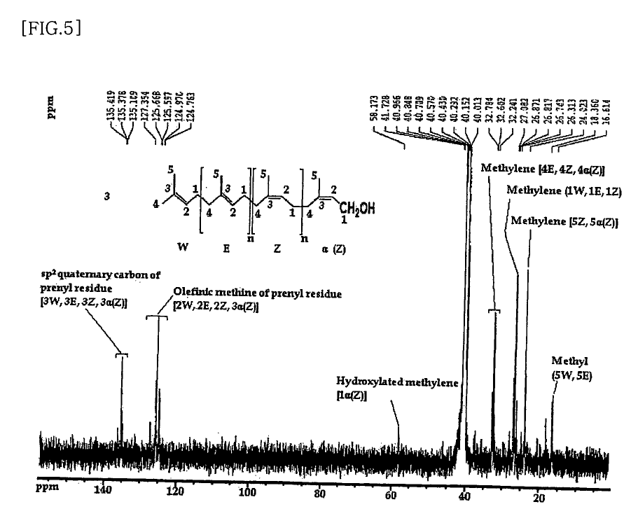

In addition, ¹H-NMR and ¹³C-NMR were carried out using a NMR (FT-NMR (600 MHz), AVANCE 600, Bruker) spectrometer. The results are shown in FIG. 4 and FIG. 5. The IR spectrum was also analyzed (Mkh 1310 instrument, 150° C., 50 Vt), and the result is: IR (KBr, cm⁻¹): 3333, 2962, 2926, 1666. From these analysis results, it was found that the purified substance above is polyprenol, particularly, undecaprenol at 44.9% yield and dodecaprenol at 42.4% yield.

### Example 3

### Formulation of Polyprenol

To evaluate the effects of polyprenol on crop yield, purified polyprenol of Example 2 was formulated. 10 mg of the purified substance and 10 mg octylphenol emulsifier were mixed and carefully blended in a mortar. The mixture was added to distilled water to prepare variable concentrations of polyprenol solution for application to crops.

### Example 4

### Isolation and Purification of Polyprenol of Formula I, in which m is 18

Five kilograms (in the undried state) of the yellowed leaves of Ginko biloba were crushed into small fragments by a mixer, and then extracted with 100 liters of a mixed solvent of petroleum ether/acetone (4:1 by volume) at about 20° C. The extract was washed with water and dried over anhydrous sodium sulfate. The solvent was distilled off to give about 100 g of a residue. One liter of n-hexane was added to the residue to dissolve n-hexane-soluble components. The solution was filtered, and the filtrate was concentrated and subjected to silica gel column chromatography using n-hexane/diethyl ether (95/5 by volume) as an eluent to separate a fraction having an Rf value of 0.52 as determined by silica gel thin-layer chromatography (TLC plate silica gel 60F₂₅₄ precoated, layer thickness 0.25 mm, made by Merck Co.; developed 10 cm) using a mixed solvent of n-hexane/ethyl acetate (9/1 by volume) as a developing solvent. Thus, about 17 g of an oily product was obtained. In the above thin-layer chromatography, solanesyl acetate had an Rf of 0.41.

The oily product was heated at 65° C. for 2 hours together with 200 ml of methanol, 20 ml of water and 10 g of sodium hydroxide. Methanol was then distilled off, and 300 ml of diethyl ether was added to the residue to perform extraction. The ethereal layer was washed with about 50 ml of water five times, and dried over anhydrous sodium sulfate. The solvent was distilled off to give 10.3 g of an oily product. The oily product was found to be a polyprenol fraction having a purity of more than 95%. This product was subjected to high-performance liquid chromatography using β-Bondapak-C₁₈ (silica gel surface-treated with a C₁₈ hydrocarbon compound) as a packing material, a mixed solvent of acetone/methanol (90/10 by volume) as a developing solvent and a differential refractometer as a detector, and the area proportions of the individual peaks in the resulting chromatography were determined.

To evaluate the effects of polyprenol on crop yield, purified polyprenol of Example 4 was formulated. 10 mg of the purified substance and 10 mg octylphenol emulsifier were mixed and carefully blended in a mortar. The mixture was added to distilled water to prepare variable concentrations of polyprenol solution for application to crops.

### Example 5

### Synthesis of the Derivatives of Polyprenols Purified in Example 2

1 g of polyprenol purified in Example 2 and 1.0 g of SOCl₂ were dissolved in toluene. By this way, polyprenyl chloride was obtained.

### Example 6

### Synthesis of the Derivatives of Polyprenols Prepared in Example 4

6-1: Synthesis of Polyprenyl Acetate

1.24 g of polyprenol prepared in Example 4 and 1.0 g of pyridine were dissolved in dry diethyl ether, and 1.2 g of acetic anhydride was added dropwise to the solution at room temperature. After the addition, the mixture was stirred overnight at room temperature. The reaction mixture was washed with a saturated aqueous solution of sodium chloride, and dried over anhydrous magnesium sulfate. The diethyl ether was distilled off to give a pale yellow viscous liquid. The product was purified by silica gel column chromatography using hexane/ethyl acetate as an eluent to give 1.08 g of a slightly yellow liquid. IR analysis of this liquid showed that the absorption at about 3,300 cm⁻¹ attributed to the OH group of the starting polyprenol disappeared, and absorptions at 1745 cm⁻¹ and 1255 cm⁻¹ attributed to —OCOCH₃ newly appeared. In NMR analysis, the signal (doublet, δ=4.08) assigned to —CH₂ OH of the starting polyprenol disappeared, and a new signal (doublet, δ=4.55) assigned to —CH₂ OCOCH₃ was observed. The signal to be assigned to —CH₂ OCOCH₃ was seen to overlap the signal (δ=2.04) assigned to:

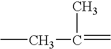

FD-MASS analysis gave m/e=1284. From these data, the resulting liquid was determined to be polyprenyl acetate of Formula I, in which m is 18 and X is —OCOCH₃. A polyprenyl acetate in which m is other than 18, and a polyprenyl acetate mixture in which m distributes arbitrarily between 14 and 22 were synthesized by a similar operation to that described above.

6-2: Synthesis of Polyprenyl Bromide

12.4 g of polyprenol prepared in Example 4 and 1 ml of pyridine were added to 200 ml of n-hexane. To the resulting solution was added dropwise 2.0 g of phosphorus tribromide under an atmosphere of nitrogen. After the addition, the mixture was stirred overnight at room temperature under an atmosphere of nitrogen. The n-hexane solution was put in a separating funnel, washed with about 50 ml of water ten-times, and then dried over anhydrous magnesium sulfate. The n-hexane was distilled off to give 12.0 g of a slightly yellow liquid product. When this product was analyzed by NMR spectroscopy, the signal (doublet, δ=4.08) assigned to the —CH₂OH group of the starting polyprenol disappeared, and a signal (doublet, δ=3.91) assigned to —CH₂Br appeared newly. FD-MASS analysis of this liquid product gave m/e=1304. From these analytical data, the above product was determined to be polyprenyl bromide of Formula I, in which m is 18 and X is Br. By a similar operation to that described above, a polyprenyl bromide in which m is other than 18, and a polyprenyl bromide mixture in which m distributes arbitrarily between 14 and 23 synthesized.

6-3: Synthesis of Polyprenyl Stearate

Polyprenol prepared in Example 4 and methyl stearate were subjected to ester exchange reaction in the same way as in Example 6-1 except that 0.3 g of methyl stearate was used instead of 0.3 g of methyl oleate. There was obtained 1.2 g of a pale yellow liquid. FD-MASS analysis gave m/e=1508 which showed that this product was a polyprenyl compound of Formula I in which m is 18 and X is —OCO—(CH₂)₁₆ CH₃. As the same manner stated above, the following compounds can be synthesized.

6-4: Synthesis of Polyprenyl Methyl Ether

1.24 g of polyprenol prepared in Example 4 was dissolved in 10 ml of a 1:1 mixture of anhydrous diethyl ether and hexane, and 0.69 ml (1.1 millimoles) of a 1.6M hexane solution of n-butyllithium was added dropwise at 0° C. The mixture was stirred for 10 minutes, and then 156 mg (1.1 millimoles) of methyl iodide was added. After additional stirring for 30 minutes, the reaction mixture was poured into water, and extracted with hexane. The hexane layer was washed with a saturated aqueous solution of sodium chloride and dried over anhydrous magnesium sulfate. The solvent was distilled off to give a yellow liquid. The liquid was purified by silica gel column chromatography using hexane/ethyl acetate as an eluent to give 1.14 g of a slightly yellow liquid. The IR analysis of the purified liquid showed that the absorption attributed to the OH group of the starting polyprenol disappeared, and an absorption attributed to the ether linkage appeared at 1120 cm⁻¹, 1100 cm⁻¹ and 1080 cm⁻¹. In the NMR spectrum, a signal assigned to —OCH₃ appeared at δ=3.27. The FD-MASS analysis gave m/e=1256. From these analytical data, the liquid product was determined to be a compound of Formula I in which m is 18 and X is —OCH₃. By a similar operation to that described above, a polyprenyl methyl ether in which m is other than 18 and a polyprenyl methyl ether mixture in which n distributes arbitrarily between 14 and 22 were synthesized.

6-5: Synthesis of Polyprenyl Methyl Sulfide

1.30 g of polyprenyl bromide prepared in Example 6-2 was dissolved in 1.5 ml of benzene, and 3 ml of a 15% aqueous solution of methylmercaptan sodium salt and 50 mg of benzyl triethyl ammonium chloride were added. The mixture was stirred vigorously overnight at 40.degree. C. The reaction mixture was cooled, and extracted with diethyl ether. The ethereal layer was washed with water and a saturated aqueous solution of sodium chloride, and dried over anhydrous magnesium sulfate. The ether was distilled off to give a yellow liquid. The liquid was purified by silica gel column chromatography using hexane as an eluent to give 0.40 g of a liquid. The NMR analysis of this liquid showed that a signal (singlet, δ=1.95) assigned to S—CH₃ and a signal (doublet, δ=2.96) assigned to —CH₂ SCH₃ appeared. The FD-MASS analysis gave m/e=1272. From these analytical data, this liquid was determined to be a compound of Formula I in which m is 18 and X is SCH₃. By a similar operation to that described above, a polyprenyl methyl sulfide in which n is other than 18 and a polyprenyl methyl sulfide mixture in which m distributes arbitrarily between 14 and 22 were synthesized.

6-6: Synthesis of Polyprenyl Ethyl Carbonate

12.4 g of polyprenol prepared in Example 4 was dissolved in 50 ml of anhydrous pyridine, and with stirring at room temperature, 4.8 ml of ethyl chloroformate was added dropwise. The mixture was stirred overnight at room temperature. The reaction mixture was poured into about 300 ml of water, and extracted with diethyl ether. The ethereal layer was washed with water, dilute hydrochloric acid and water in this order, dried and concentrated to give a yellow liquid. This liquid was chromatographed on a silica gel column using hexane/ethyl acetate as an eluent to give 7.21 of a slightly yellow liquid. The NMR analysis of this liquid shoed that the signal (doublet, δ=4.08) assigned to —CH₂OH of the starting polyprenol disappeared, and a signal (doublet, δ=4.45) assigned to —CH₂O and signals (triplet, δ=1.20 and quartet, δ=4.05) assigned to

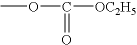

newly appeared. The FD-MASS analysis of this product gave m/e=1314. From these analytical data, the liquid was determined to be polyprenyl ethyl carbonate of Formula I in which n is 18 and X is

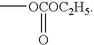

By a similar operation to that described hereinabove, a polyprenyl ethyl carbonate in which m is other than 18 and a polyprenyl ethyl carbonate mixture in which n distributes arbitrarily between 14 and 22 were synthesized.

6-7: Synthesis of Polyprenyl Dimethyl Sulfonium Bromide

2.6 g of polyprenyl bromide prepared in Example 6-2 was added to 10 ml of dimethyl sulfide and the mixture was left to stand overnight at room temperature. Consequently, a yellow waxy material precipitated. The precipitate was separated and washed thoroughly with anhydrous diethyl ether, and then the solvent was removed under reduced pressure to give 1.27 g of a yellow waxy product. The NMR analysis of this product showed that the signal (doublet, δ=3.91) assigned to —CH₂Br of the starting polyprenyl bromide disappeared, and a signal (doublet, δ=4.15) assigned to

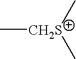

and a signal (singlet, δ=2.88) assigned to +S(CH₃)₂ newly appeared. Since this product was highly hygroscopic, its elemental analysis was impossible. FD-MASS analysis was also impossible because the product was a sulfonium salt. The NMR analysis, however, led to the determination that the product was the desired polyprepyl dimethyl sulfonium bromide of Formula I in which m is 18 and X is +—S(CH₃)₂Br—. By a similar operation to that described above, polyprenyl dimethyl sulfonium bromide in which m is other than 18 and a polyprenyl dimethyl sulfonium bromide mixture in which m distributes arbitrarily between 14 and 22 were synthesized.

### Example 7

### Evaluation of Effects on Germination of the Crops

7-1: Evaluation of Effect on Germination of Corn

100 g of corn seeds were immersed in 100 ml of the polyprenol preparations in Example 3 at concentrations of 10 and 100 ppm, respectively, for 2 hrs. The treated seeds were dried for 24 hrs. at room temperature, and 100 seeds each were placed in a petri dish with overlaid paper, followed by the addition of 20 ml distilled water at 25° C. After 3 days, the germination rate was observed. The germination test was repeated 5 times, and the average values were calculated, represented in Table 1 below. The germination rate is calculated by that number of germinated seeds is divided by number of total seeds in percentage. As a control, corn seeds which were not immersed in the polyprenol preparation were used.

TABLE 1
Comparison of the germination rates of corn

| Concentration of | Germination | |
|---|---|---|
| Polyprenol (ppm) | rate (%) | Rate of increase (%) |
| 10 | 64 | 7 |
| 100 | 78 | 30 |
| Control | 60 | — |

7-2: Evaluation of Effect on Germination of Spinach

The effect of the polyprenol preparation on the germination of spinach was evaluated according to the same method as in Example 7-1, except that spinach seeds were used instead of corn seeds, and the concentrations of polyprenol preparations were 10 and 50 ppm, respectively. The results are represented in Table 2 below.

TABLE 2
Comparison of the germination rates of spinach

| Concentration of | Germination | |
|---|---|---|
| Polyprenol (ppm) | rate (%) | Rate of increase (%) |
| 10 | 59 | 11 |
| 50 | 76 | 43 |
| Control | 53 | — |

As shown in Table 1, the germination rate of the corn treated with the polyprenol preparation was increased by 30% where the applied concentration of polyprenol is 100 ppm, in comparison with the control corn. Likewise, as shown in Table 2, the germination rates were more than 50% on spinach seeds when polyprenol was applied, being increased by 11 to 43% compared to the control spinach.

### Example 8

### Evaluation of Effects on Crop Yield

8-1: Evaluation of Effect on Wheat Yield

Wheat seeds and polyprenol prepared in Example 3 at the amounts corresponding to 1 g and 10 g polyprenol, respectively, per 1 ton of seeds were blended at a rotation speed of 68 rpm for 3 to 5 min by an agitator. Then, the treated seeds were dried for 2 to 3 hrs in a drying oven at 50° C., and 180 to 200 kg of seeds per hectare were sown in Pochun, Kyunggido of Korea. After 150 days, the crop yield was calculated by fresh weight ratio. The test was repeated 4 times, and the average values are represented in Table 3. As shown in Table 3 below, the yield of winter wheat of which seeds were treated with polyprenol was increased by more than 40%, in comparison with the control where polyprenol was not treated. Also, as for summer wheat, the yield was increased by 12 to 33%, compared to the control.

TABLE 3
Comparison of the yield of wheat

| | Amount of polyprenol(g) | Yield | Rate of increase |
|---|---|---|---|
| | (per 1 ton seeds) | (ton/ha) | (%) |
| Winter | 1 | 2.82 | 43 |
| wheat | 10 | 2.87 | 46 |
| | Control | 1.97 | — |
| Summer | 1 | 6.28 | 23 |
| wheat | 10 | 5.71 | 12 |
| | Control | 5.11 | — |

8-2: Evaluation of Effect on Corn Yield

The effect of polyprenol prepated in Example 3 on corn yield was evaluated according to the same method as in Example 8-1, except that corn seeds were used, instead of wheat seeds, and the amounts of polyprenol were 1, 10 and 100 g, respectively. The results are represented in Table 4 below.

TABLE 4
Comparison of the yield of corn

| | Amount of polyprenol(g) | Yield | Rate of increase |
|---|---|---|---|
| | (per 1 ton seeds) | (ton/ha) | (%) |
| Corn | 1 | 4.82 | −5.7 |
| hybrid 1 | 10 | 6.30 | 23.3 |
| | 100 | 6.83 | 33.9 |
| | Control | 5.11 | — |
| Corn | 1 | 8.60 | 0.5 |
| Hybrid 2 | 10 | 8.62 | 1.2 |
| | 100 | 9.42 | 10.5 |
| | Control | 8.56 | — |

8-3: Evaluation of Effect on Cucumber Yield

The effect of polyprenol prepared in Example 3 on cucumber yield was evaluated according to the same method as in Example 8-1, except that cucumber seeds were used, instead of wheat seeds, and the amounts of polyprenol were 10 and 100 g, respectively. The results are represented in Table 5 below.

TABLE 5
Comparison of the yield of cucumber

| Amount of polyprenol(g) | Yield | Rate of increase |
|---|---|---|
| (per 1 ton seeds) | (ton/ha) | (%) |
| 10 | 3.88 | 12.1 |
| 100 | 5.79 | 67.3 |
| Control | 3.46 | — |

8-4: Evaluation of effect on rice yield

100 g of rice seeds were immersed in 100 ml solutions containing the polyprenol preparation formulated in Example 3 at concentrations of 1, 5, 10, 20 and 50 ppm, respectively, for 2 hrs. Then, the treated seeds were dried for 24 hrs at 25° C. Square pots of 60 cm in length (20 L capacity) were filled with soil for horticulture, and 50 pots (20 seeds per pot) were sown. After 150 days (from May to October) on the open field in Suwon, Kyunggido of Korea, the crop yield was calculated by fresh weight ratio. The test was repeated 3 times, and the average values are represented in Table 6. As a control, seeds which were not immersed in the polyprenol preparation were used.

The calculation method of weight of one thousand seeds is that 1000 seeds sampled randomly were dried in room temperature and were weighed twice. And the weighted values were averaged.

TABLE 6
Comparison of the yield of rice

| Conc. of | | | Weight of one | |
|---|---|---|---|---|
| polyprenol | No. of ears per | Rate of | thousand seeds | Rate of |
| (ppm) | plant | increase (%) | (g) | increase (%) |
| 1 | 26.9 | 17.5 | 32.6 | 14.3 |
| 5 | 26.7 | 16.6 | 32.6 | 14.4 |
| 10 | 27.6 | 20.5 | 32.9 | 15.4 |
| 20 | 27.1 | 18.3 | 31.9 | 11.9 |
| 50 | 27.2 | 18.8 | 29.6 | 10.4 |
| Control | 22.9 | — | 28.5 | — |

As shown in Table 3, the yields of both winter wheat and summer wheat of which seeds were treated with the polyprenol preparation according to Example 3 were increased by more than 10%, in comparison with the control wheat of which the seeds were not treated with the polyprenol preparation. Also, as shown in Table 4, when the corn seeds were treated with the polyprenol preparation, the yield was increased by more than 10%, compared to the untreated control. On the other hand, when the cucumber seeds were immersed in the solution of 100 g polyprenol preparation with respect to 1 ton of seeds, the cucumber yield was increased by more than 60%, as shown in Table 5. Such a result demonstrates that the polyprenol exerts a stronger effect on the cucumber crop than the other crops. Additionally, as shown in Table 6, when the rice seeds were treated with the polyprenol preparation, the number of ears was increased by more than 16%, compared to the untreated control. The weight of one thousand seeds, also, was increased by more than 10%, compared to the control.

### Example 9

### Evaluation of Effects on Crop Growth

9-1: Evaluation of Effect on Growth of Bean

100 g of bean seeds were immersed in a 100 ml solution containing the polyprenol preparation formulated in Example 3 at a concentration of 100 ppm, for 1 hr. Then, the treated seeds were dried for 24 hrs at 25° C. Round pots of 25 cm in diameter (7 L capacity) were filled with soil for horticulture, and 50 pots (2 seeds per pot) were sown. After 60 days at about 25° C., the crop growth was evaluated by rate of emergence and early plant height. The test was repeated 3 times, and the average values are represented in Table 7. As a control, bean seeds which were not immersed in the polyprenol preparation were used.

TABLE 7
Comparison of the growth of bean

| | | Treatment with 100 ppm | Rate of |
|---|---|---|---|
| Factor | Control | polyprenol | increase (%) |
| Early plant height(cm) | 63.3 | 75.0 | 18.5 |
| Rate of emergence (%) | 51.9 | 61.2 | 18.0 |
| No. of pods | 30.2 | 40.4 | 33.8 |

9-2: Evaluation of Effect on Growth of Corn

The effect of the polyprenol preparation on corn growth was evaluated according to the same method as in Example 9-1, except that corn seeds were used, instead of bean seeds, and the time of immersion was 2 hrs. The results are represented in Table 8 below.

TABLE 8
Comparison of the growth of corn

| | | Treatment with 100 ppm | Rate of |
|---|---|---|---|
| Factor | Control | polyprenol | increase (%) |
| Early plant height(cm) | 108.6 | 111.1 | 2.3 |
| Tiller number | 8.2 | 9.2 | 12.1 |
| Fresh weight(g) | 52.0 | 84.0 | 62.0 |

9-3: Evaluation of Effect on Growth of Rice

The effect of the polyprenol preparation on rice growth was evaluated according to the same method as in Example 9-1, except that rice seeds were used, instead of bean seeds, and the time of immersion was 2 hrs. The results are represented in Table 9 below.

TABLE 9
Comparison of the growth of rice

| | | Treatment with 100 ppm | Rate of |
|---|---|---|---|
| Factor | Control | polyprenol | increase (%) |
| Early plant height(cm) | 18.5 | 20.2 | 9.2 |
| Root length(cm) | 9.2 | 9.9 | 7.2 |
| Tiller number | 1.8 | 2.0 | 11.1 |
| Fresh weight(mg) | 665.4 | 747.8 | 12.4 |

9-4: Evaluation of Effect on Growth of Radish

The effect of the polyprenol preparation on radish growth was evaluated according to the same method as in Example 9-1, except that radish seeds were used, instead of bean seeds, and the time of immersion was 2 hrs. The results are represented in Table 10 below.

TABLE 10
Comparison of the growth of radish

| | | Treatment with 100 ppm | Rate of |
|---|---|---|---|
| Factor | Control | polyprenol | increase (%) |
| Leaf number | 5.2 | 5.3 | 1.9 |
| Leaf length(cm) | 15.8 | 15.8 | 11.3 |
| Leaf width(cm) | 6.3 | 7.1 | 12.7 |
| Fresh weight(g) | 7.9 | 9.6 | 21.5 |

9-5: Evaluation of Effect on Growth of Bell Tomato

The effect of the polyprenol preparation on bell tomato growth was evaluated according to the same method as in Example 9-1, except that bell tomato seeds were used, instead of bean seeds, and the time of immersion was 2 hrs. The results are represented in Table 11 below.

TABLE 11
Comparison of the growth of bell tomato

| | | Treatment with 100 ppm | Rate of |
|---|---|---|---|
| Factor | Control | polyprenol | increase (%) |
| Plant length(cm) | 28.2 | 32.9 | 16.7 |
| Trunk diameter(mm) | 4.1 | 4.7 | 14.6 |
| Fresh weight(g) | 3.9 | 5.6 | 43.6 |

9-6: Evaluation of Effect on Growth of Red Pepper

The effect of the polyprenol preparation on red pepper growth was evaluated according to the same method as in Example 9-1, except that red pepper seeds were used, instead of bean seeds, and the crop was subjected to foliage treatment after growing for 20 days. The results are represented in Table 12 below.

TABLE 12
Comparison of the growth of red pepper

| | | Treatment with 100 ppm | Rate of |
|---|---|---|---|
| Factor | Control | polyprenol | increase(%) |
| Early plant length(cm) | 63.1 | 73.0 | 15.7 |
| Flower number | 7.6 | 9.9 | 30.7 |
| Trunk diameter(mm) | 8.4 | 8.4 | 0.0 |

9-7: Evaluation of Effect on Growth of Root in Gerbera

10 g of gerbera seeds were immersed in 100 ml of the polyprenol preparations formulated in Example 3 at concentrations of 1, 5, 10 and 25 ppm, respectively, for 2 hrs. The treated seeds were dried for 24 hrs at room temperature, and 10 seeds each were placed in a petri dish with overlaid paper, followed by the addition of 10 ml distilled water. After 30 days at 25° C., the roots were counted. The test was repeated 5 times, and the average values were calculated, represented in Table 13 below. As a control, the gerbera seeds which were not immersed in the polyprenol preparation were used.

TABLE 13
Comparison of the growth of gerbera

| Conc. of polyprenol(ppm) | Root number | Rate of increment(%) |
|---|---|---|
| 1 | 2.1 | 0 |
| 5 | 2.9 | 38.1 |
| 10 | 3.6 | 71.4 |
| 25 | 4.1 | 95.2 |
| Control | 2.1 | — |

### Example 10: Evaluation of Effects on Crop Growth with the Compound Prepared in Example 4

10-1: Evaluation of Effect on Growth of Bean

In example 4, the compound having chloride group instead of hydroxyl group can be synthesized. The compound was evaluated on effect on crop growth. 100 g of bean seeds were immersed in a 100 ml solution containing the polyprenol preparation formulated in Example 4 at a concentration of 100 ppm, for 1 hr. Then, the treated seeds were dried for 24 hrs. Round pots of 25 cm in diameter (7 L capacity) were filled with soil for horticulture, and 50 pots (2 seeds per pot) were sown. After 60 days, the crop growth was evaluated. The test was repeated 3 times, and the average values are represented in Table 14. As a control, bean seeds which were not immersed in the polyprenol preparation were used.

TABLE 14
Comparison of the growth of bean

| | | Treatment with 100 ppm | Rate of |
|---|---|---|---|
| Factor | Control | polyprenol | increase (%) |
| Early plant height(cm) | 63.3 | 68.2 | 7.74 |
| Rate of emergence (%) | 51.9 | 55.7 | 7.32 |
| No. of pods | 30.2 | 35.4 | 17.2 |

10-2: Evaluation of Effect on Growth of Red Pepper

The effect of the polyprenol preparation on red pepper growth was evaluated according to the same method as in Example 10-1, except that red pepper seeds were used, instead of bean seeds, and the crop was subjected to foliage treatment after growing for 20 days. The results are represented in Table 15 below.

TABLE 15
Comparison of the growth of red pepper

| | | Treatment with 100 ppm | Rate of |
|---|---|---|---|
| Factor | Control | polyprenol | increase(%) |
| Early plant length(cm) | 63.1 | 70.5 | 11.7 |
| Flower number | 7.6 | 8.4 | 10.5 |
| Trunk diameter(mm) | 8.4 | 8.5 | 1.2 |

### Example 11

### Evaluation of Effects on Crop Growth with the Compound Prepared in Example 5

11-1: Evaluation of Effect on Growth of Bean

100 g of bean seeds were immersed in a 100 ml solution containing the polyprenol preparation formulated in Example 5 at a concentration of 100 ppm, for 1 hr. Then, the treated seeds were dried for 24 hrs. Round pots of 25 cm in diameter (7 L capacity) were filled with soil for horticulture, and 50 pots (2 seeds per pot) were sown. After 60 days, the crop growth was evaluated. The test was repeated 3 times, and the average values are represented in Table 16. As a control, bean seeds which were not immersed in the polyprenol preparation were used.

TABLE 16
Comparison of the growth of bean

| | | Treatment with 100 ppm | Rate of |
|---|---|---|---|
| Factor | Control | polyprenol | increase (%) |
| Early plant height(cm) | 63.3 | 73.5 | 16.1 |
| Rate of emergence (%) | 51.9 | 59.8 | 15.2 |
| No. of pods | 30.2 | 38.7 | 28.1 |

11-2: Evaluation of Effect on Growth of Corn

The effect of the polyprenol preparation on corn growth was evaluated according to the same method as in Example 11-1, except that corn seeds were used, instead of bean seeds, and the time of immersion was 2 hrs. The results are represented in Table 17 below.

TABLE 17
Comparison of the growth of corn

| | | Treatment with 100 ppm | Rate of |
|---|---|---|---|
| Factor | Control | polyprenol | increase (%) |
| Early plant height(cm) | 108.6 | 110.4 | 1.6 |
| Tiller number | 8.2 | 9.0 | 9.7 |
| Fresh weight(g) | 52.0 | 78.3 | 50.5 |

### Example 12

### Evaluation of Effects on Crop Growth with the Compound Prepared in Example 6

12-1: Evaluation of Effect on Growth of Rice

The effect of the polyprenol preparation on rice growth was evaluated according to the same method as in Example 9-1, except that rice seeds were used, instead of bean seeds, and the time of immersion was 2 hrs. The results are represented in Table 18 below.

TABLE 18
Comparison of the growth of rice

| | | Treatment with 100 ppm | Rate of |
|---|---|---|---|
| Factor | Control | polyprenol | increase (%) |
| Early plant height(cm) | 18.5 | 19.5 | 5.4 |
| Root length(cm) | 9.2 | 9.5 | 3.2 |
| Tiller number | 1.8 | 1.9 | 5.5 |
| Fresh weight(mg) | 665.4 | 720.1 | 8.2 |

12-2: Evaluation of Effect on Growth of Radish

The effect of the polyprenol preparation on radish growth was evaluated according to the same method as in Example 9-1, except that radish seeds were used, instead of bean seeds, and the time of immersion was 2 hrs. The results are represented in Table 19 below.

TABLE 19
Comparison of the growth of radish

| | | Treatment with 100 ppm | Rate of |
|---|---|---|---|
| Factor | Control | polyprenol | increase (%) |
| Leaf number | 5.2 | 5.2 | 0.0 |
| Leaf length(cm) | 15.8 | 15.9 | 0.6 |
| Leaf width(cm) | 6.3 | 6.5 | 3.1 |
| Fresh weight(g) | 7.9 | 8.8 | 11.3 |

12-3: Evaluation of Effect on Growth of Corn with the Compound of Example 6-3

The effect of the polyprenol preparation on corn growth was evaluated according to the same method as in Example 9-1, except that corn seeds were used, instead of bean seeds, and the time of immersion was 2 hrs. The results are represented in Table 20 below.

TABLE 20
Comparison of the growth of corn with the compound
of Example 6-3

| | | Treatment with 100 ppm | Rate of |
|---|---|---|---|
| Factor | Control | polyprenol | increase (%) |
| Early plant height(cm) | 108.6 | 109.1 | 0.4 |
| Tiller number | 8.2 | 8.6 | 4.8 |
| Fresh weight(g) | 52.0 | 68.0 | 30.7 |

12-4: Evaluation of Effect on Growth of Corn with the Compound of Example 6-4

The effect of the polyprenol preparation on corn growth was evaluated according to the same method as in Example 9-1, except that corn seeds were used, instead of bean seeds, and the time of immersion was 2 hrs. The results are represented in Table 21 below.

TABLE 21
Comparison of the growth of corn with the compound of Example 6-4

| | | Treatment with 100 | Rate of |
|---|---|---|---|
| Factor | Control | ppm polyprenol | increase (%) |
| Early plant height (cm) | 108.6 | 110.1 | 1.3 |
| Tiller number | 8.2 | 8.7 | 6.0 |
| Fresh weight (g) | 52.0 | 60.3 | 15.9 |

12-5: Evaluation of Effect on Growth of Corn with the Compound of Example 6-5

The effect of the polyprenol preparation on corn growth was evaluated according to the same method as in Example 9-1, except that corn seeds were used, instead of bean seeds, and the time of immersion was 2 hrs. The results are represented in Table 22 below.

TABLE 22
Comparison of the growth of corn with the compound of Example 6-5

| | | Treatment with 100 | Rate of |
|---|---|---|---|
| Factor | Control | ppm polyprenol | increase (%) |
| Early plant height (cm) | 108.6 | 108.9 | 0.2 |
| Tiller number | 8.2 | 8.5 | 3.6 |
| Fresh weight (g) | 52.0 | 65.7 | 26.3 |

12-6: Evaluation of Effect on Growth of Corn with the Compound of Example 6-6

The effect of the polyprenol preparation on corn growth was evaluated according to the same method as in Example 9-1, except that corn seeds were used, instead of bean seeds, and the time of immersion was 2 hrs. The results are represented in Table 8 below.

TABLE 23
Comparison of the growth of corn with the compound of Example 6-6

| | | Treatment with 100 | Rate of |
|---|---|---|---|
| Factor | Control | ppm polyprenol | increase (%) |
| Early plant height (cm) | 108.6 | 109.6 | 0.9 |
| Tiller number | 8.2 | 8.4 | 2.4 |
| Fresh weight (g) | 52.0 | 61.3 | 17.8 |

12-7: Evaluation of Effect on Growth of Corn with the Compound of Example 6-7

The effect of the polyprenol preparation on corn growth was evaluated according to the same method as in Example 9-1, except that corn seeds were used, instead of bean seeds, and the time of immersion was 2 hrs. The results are represented in Table 24 below.

TABLE 24
Comparison of the growth of corn with the compound of Example 6-7

| | | Treatment with 100 | Rate of |
|---|---|---|---|
| Factor | Control | ppm polyprenol | increase (%) |
| Early plant height (cm) | 108.6 | 109.5 | 0.8 |
| Tiller number | 8.2 | 9.2 | 12.1 |
| Fresh weight (g) | 52.0 | 70.1 | 34.8 |

With regard to effects of the polyprenol preparation on the growth of crops, as shown in Table 7, it was found that when the bean seeds were treated with the polyprenol preparation, all factors tested, i.e., early plant height, rate of emmergence and pod number showed increases of more than 10%, in comparison with the control. Also, as shown in Table 8, where the corn seeds were immersed in the polyprenol preparation, all factors tested, i.e., early plant height, tiller number and fresh weight showed increases of about 2 to 60%, compared to the untreated control.

Likewise, as shown in Table 9, where the rice seeds were treated with the polyprenol preparation, all factors tested, i.e., plant height, root length, tiller number and fresh weight showed increases of about 7 to 12%, compared to the untreated control. Also, as shown in Table 10, when the radish seeds were immersed in the polyprenol solution, all factors tested except leaf number, i.e., leaf length, leaf width and fresh weight showed increases of more than 10%, compared to the untreated control. Additionally, as shown in Table 11, when the bell tomato seeds were treated with the polyprenol solution, the fresh weight of bell tomato was increased by more than 40%, compared to the untreated control. (01231 In the case of red pepper, as shown in Table 12, the flower number was increased by more than 30%, compared to the control, when the plant was applied with the polyprenol preparation by foliar treatment. In the case of gerbera, as shown in Table 13, it was found that where the seeds were immersed in a solution of 25 ppm polyprenol, the rate of increase in the root number was more than 95%, in comparison with the control gerbera seeds which were not immersed in the polyprenol solution.

With regard to effects of the polyprenol preparation according to example 4 on the growth of crops, as shown in Table 14, it was found that when the bean seeds were treated with the polyprenol preparation, all factors tested, i.e., early plant height, rate of emmergence and pod number showed increases of more than 7%, in comparison with the control. Also, as shown in Table 15, where the red pepper seeds were immersed in the polyprenol preparation, all factors tested, i.e., early plant height, flower number and trunk diameter showed increases of about 1 to 11%, compared to the untreated control.

Likewise, as shown in Table 16, where the bean seeds were treated with the polyprenol preparation prepared in example 5, all factors tested, i.e., early plant height, rate of emergence, and no. of pods showed increases of about 15 to 28%, compared to the untreated control. Also, as shown in Table 17, when the corn seeds were immersed in the polyprenol solution prepared in example 5, all factors tested except leaf number, i.e., early plant height, tiller number, and fresh weight showed increases about 1 to 50%, compared to the untreated control.

Likewise, as shown in from Table 18 to Table 24, where the rice seeds, radish seeds, corn seeds were treated with the polyprenol preparation prepared in from example 6-1 to example 6-7, all factors tested, i.e., early plant height, root length, tiller number and fresh weight, etc. showed increases of about 0 to 34%, compared to the untreated control.

From these results described above, it could be seen that polyprenol is beneficial to crops in terms of germination, crop yield, and growth of stems and roots.

As apparent from the above description, the present inventors demonstrated that a plant growth regulator comprising polyprenol as an active ingredient is effective in terms of the germination, growth, and especially yield, of crops. The plant growth regulator according to embodiments of the invention has advantages over conventional plant growth regulators. It is a natural product, so there is no toxicity to the environment or human body. Also, it can be produced at low cost. Further, the plant growth regulator can improve productivity of crops, and increase crop yield in cereals whose market size is larger than that of vegetables and fruits, thus being capable of contributing to agricultural development.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A composition comprising:
water;
an emulsifier;
at least one compound represented by Formula I: 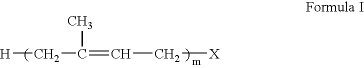
wherein “m” is an integer from about 3 to about 33; and
wherein “X” is a substituent group selected from the group consisting of: (a) hydroxyl and acetyloxy; (b) halo; (c) formyl, mono-fluoroacetyloxy, trifluoroacetyloxy, monochloroacetyloxy, propionyloxy, butyryloxy, stearoyloxy, benzoyloxy, 3,5-dimethylbenzoyloxy, and 4-ethylbenzoyloxy; (d) methoxy, ethoxy, phenoxy, 2-pyridyloxy, 2-benzothiazolyloxy, 2-benzoxazolyloxy, trimethylsilyloxy, dimethyl t-butylsilyloxy, methylthio, ethylthio, phenylthio, tolylthio, 2-thiazolinylthio, 2-benzothiazolylthio, 2-benzoxazolylthio, and 2-pyridylthio; (e) dimethylphosphonoxy, diethylphosphonoxy, and diphenylphosphonoxy; (f) methylsulfinyl, ethylsulfinyl, propylsulfinyl, phenylsulfinyl, and 4-tolylsulfinyl; (g) methylsulfonyl, ethylsulfonyl, propylsulfonyl, phenylsulfonyl, and 4-tolylsulfonyl; (h) methoxycarbonyloxy, ethoxycarbonyloxy, propoxycarbonyloxy, phenoxycarbonyloxy, and 4-tolyloxycarbonyloxy; (i) N,N-dimethylcarbamoyloxy, N,N-diethylcarbamoyloxy, N,N-dipropylcarbamoyloxy, N,N-diphenylcarbamoyloxy, and N-phenyl-N-ethylcarbamoyloxy; (j) trimethylammonium bromide, triethylammonium iodide and diphenylethylammonium bromide; (k) dimethylsulfonium bromide, diethylsulfonium iodide, dipropylsulfonium bromide, and phenylethylsulfonium bromide; and (l) monophosphate, diphosphate, and triphosphate.

2. The composition of claim 1, wherein “m” is from about 8 to about 23.

3. The composition of claim 1, wherein “m” is from about 10 to about 18.

4. The composition of claim 1, wherein the emulsifier comprises one or more selected from the group consisting octylphenol, polyoxyethylene, polyethyleneglycol fatty acid esters, ethylene glycol fatty acid esters, glycerol fatty acid esters, sucrose fatty acid esters, propylene glycol fatty acid esters, and sorbitan fatty acid or sorbitan fatty acid ester.

5. The composition of claim 1, wherein the compound has a concentration from about 1 ppm to about 100 ppm.

6. The composition of claim 1, wherein the compound has a concentration from about 0.01 wt % to about 80 wt % with reference to the total weight of the composition.

7. A composition comprising:
water;
an emulsifier;
at least one compound represented by Formula II: 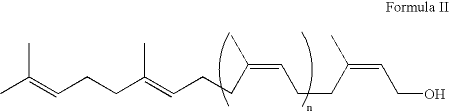
wherein “n” is an integer from 0 to about 30.

8. The composition of claim 7, wherein “n” is from about 5 to about 20.

9. The composition of claim 7, wherein “n” is from about 7 to about 15.

10. The composition of claim 7, wherein the compound is undecaprenol or dodecaprenol.

11. A method of treating a plant, comprising:
providing a plant; and
contacting the plant or a portion thereof with at least one compound represented by Formula I: 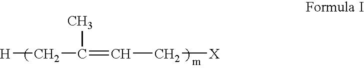
wherein “m” is an integer from about 3 to about 33;
wherein “X” is a substituent group selected from the group consisting of: (a) hydroxyl and acetyloxy; (b) halo; (c) formyl, mono-fluoroacetyloxy, trifluoroacetyloxy, monochloroacetyloxy, propionyloxy, butyryloxy, stearoyloxy, benzoyloxy, 3,5-dimethylbenzoyloxy, and 4-ethylbenzoyloxy; (d) methoxy, ethoxy, phenoxy, 2-pyridyloxy, 2-benzothiazolyloxy, 2-benzoxazolyloxy, trimethylsilyloxy, dimethyl t-butylsilyloxy, methylthio, ethylthio, phenylthio, tolylthio, 2-thiazolinylthio, 2-benzothiazolylthio, 2-benzoxazolylthio, and 2-pyridylthio; (e) dimethylphosphonoxy, diethylphosphonoxy, and diphenylphosphonoxy; (f) methylsulfinyl, ethylsulfinyl, propylsulfinyl, phenylsulfinyl, and 4-tolylsulfinyl; (g) methylsulfonyl, ethylsulfonyl, propylsulfonyl, phenylsulfonyl, and 4-tolylsulfonyl; (h) methoxycarbonyloxy, ethoxycarbonyloxy, propoxycarbonyloxy, phenoxycarbonyloxy, and 4-tolyloxycarbonyloxy; (i) N,N-dimethylcarbamoyloxy, N,N-diethylcarbamoyloxy, N,N-dipropylcarbamoyloxy, N,N-diphenylcarbamoyloxy, and N-phenyl-N-ethylcarbamoyloxy; (j) trimethylammonium bromide, triethylammonium iodide and diphenylethylammonium bromide; (k) dimethylsulfonium bromide, diethylsulfonium iodide, dipropylsulfonium bromide, and phenylethylsulfonium bromide; and (l) monophosphate, diphosphate, and triphosphate.

12. The method of claim 11, wherein the portion of the plant contacted with the compound is one or more selected from the group consisting of a seed, a shoot, a root, a leaf, a bulb, a fruit, a stem, a trunk, a stalk, a cane, a flower, a flower bud and a surface of the foregoings.

13. The method of claim 11, wherein the plant is selected from the group consisting of vegetable or fruit plants, grain plants and ornamental plants.

14. The method of claim 13, wherein the vegetable or fruit plants are selected from the group consisting of tobacco, grape, strawberry, tomato, bell tomato, cucumber, potato, radish, cabbage, bean sprout, red pepper and spinach; wherein the grain plants are selected from the group consisting of rice, barley, corn, millet, bean and wheat; and wherein the ornamental plants are selected from the group consisting of chrysanthemum, rose, lily and gerbera.

15. The method of claim 11, wherein “m” is from about 8 to about 23.

16. The method of claim 11, wherein “m” is from about 10 to about 18.

17. The method of claim 11, wherein “X” is hydroxyl or acetyloxy.

18. The method of claim 11, wherein the compound is contacted with the plant or a portion thereof in the form of liquid.

19. The method of claim 11, wherein the compound is contacted with the plant or a portion thereof in the form of powder.

20. The method of claim 11, wherein the compound is contacted with the plant or a portion thereof along with a non-Formula I substance.

21. The method of claim 20, wherein the non-Formula I substance comprises at least one of an emulsifier and water.

22. The method of claim 21, wherein the emulsifier comprises one or more selected from the group consisting octylphenol, polyoxyethylene, polyethyleneglycol fatty acid esters, ethylene glycol fatty acid esters, glycerol fatty acid esters, sucrose fatty acid esters, propylene glycol fatty acid esters, and sorbitan fatty acid or sorbitan fatty acid ester.

23. The method of claim 21, wherein the compound contacting the plant or a portion thereof has a concentration from about 0.01 ppm to about 1000 ppm.

24. The method of claim 21, wherein the compound contacting the plant or a portion thereof has a concentration from about 1 ppm to about 100 ppm.

25. The method of claim 11, wherein the compound is contacted with the plant or a portion thereof by sprinkling liquid or powder comprising the compound over the plant or the portion thereof.

26. The method of claim 11, wherein the compound is contacted with the plant or a portion thereof by immersing at least a portion of the plant in a liquid comprising the compound.

27. The method of claim 11, wherein the compound is contacted with the plant or a portion thereof by injecting a composition comprising the compound into the plant or the portion thereof.

28. The method of claim 11, further comprising cutting at least a portion of the plant so as to contact the compound with an interior of the plant.

29. The method of claim 11, further comprising peeling a skin of the plant or a portion thereof so as to directly contact the compound with an interior of the plant.

30. The method of claim 11, wherein the plant or a portion thereof is contacted with the compound one or more times.

31. The method of claim 11, wherein the plant or a portion thereof is contacted with the compound sporadically.

32. The method of claim 11, wherein the plant or a portion thereof is contacted with the compound periodically.

33. The method of claim 11, further comprising maintaining the plant or a portion thereof in a condition sufficient to grow the plant.

34. The method of claim 11, further comprising harvesting the plant or a portion thereof.

35. A grown plant from the plant or the portion treated by the method of claim 11.

36. The plant of claim 35, wherein the portion of the plant is one or more selected from the group consisting of a seed, a shoot, a root, a leaf, a bulb, a fruit, a stem, a trunk, a stalk, a cane, a flower, a flower bud and a surface of the foregoings, and wherein the plant or the portion comprises a scientifically traceable amount of compound.

37. A method of treating a plant, comprising:
providing a plant; and
contacting the plant or a portion thereof with at least one compound represented by Formula II: 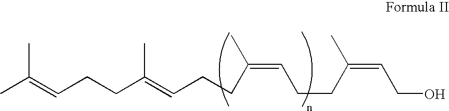
wherein “n” is an integer from 0 to about 30.

38. The method of claim 37, wherein “n” is from about 5 to about 20.

39. The method of claim 37, wherein “n” is from about 7 to about 15.

40. The method of claim 37, wherein “n” is 8, 9 or 15.

41. The method of claim 37, wherein the compound contacting with the plant or the portion thereof comprises one or more different forms thereof, and wherein the different forms of the compound have different “n”.

42. The method of claim 37, wherein the plant is selected from the group consisting of vegetable or fruit plants, grain plants and ornamental plants.

43. A plant treated with a chemical compound, comprising:
a body of a plant, the body comprising an outer surface; and
at least one compound of Formula I on the outer surface: 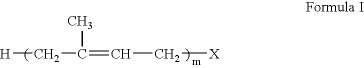
wherein “m” is an integer from about 3 to about 33;
wherein “X” is a substituent group selected from the group consisting of: (a) hydroxyl and acetyloxy; (b) halo; (c) formyl, mono-fluoroacetyloxy, trifluoroacetyloxy, monochloroacetyloxy, propionyloxy, butyryloxy, stearoyloxy, benzoyloxy, 3,5-dimethylbenzoyloxy, and 4-ethylbenzoyloxy; (d) methoxy, ethoxy, phenoxy, 2-pyridyloxy, 2-benzothiazolyloxy, 2-benzoxazolyloxy, trimethylsilyloxy, dimethyl t-butylsilyloxy, methylthio, ethylthio, phenylthio, tolylthio, 2-thiazolinylthio, 2-benzothiazolylthio, 2-benzoxazolylthio, and 2-pyridylthio; (e) dimethylphosphonoxy, diethylphosphonoxy, and diphenylphosphonoxy; (f) methylsulfinyl, ethylsulfinyl, propylsulfinyl, phenylsulfinyl, and 4-tolylsulfinyl; (g) methylsulfonyl, ethylsulfonyl, propylsulfonyl, phenylsulfonyl, and 4-tolylsulfonyl; (h) methoxycarbonyloxy, ethoxycarbonyloxy, propoxycarbonyloxy, phenoxycarbonyloxy, and 4-tolyloxycarbonyloxy; (i) N,N-dimethylcarbamoyloxy, N,N-diethylcarbamoyloxy, N,N-dipropylcarbamoyloxy, N,N-diphenylcarbamoyloxy, and N-phenyl-N-ethylcarbamoyloxy; (j) trimethylammonium bromide, triethylammonium iodide and diphenylethylammonium bromide; (k) dimethylsulfonium bromide, diethylsulfonium iodide, dipropylsulfonium bromide, and phenylethylsulfonium bromide; and (l) monophosphate, diphosphate, and triphosphate.

44. The plant of claim 43, wherein the plant body is one or more selected from the group consisting of a seed, a shoot, a root, a leaf, a bulb, a fruit, a stem, a trunk, a stalk, a cane, a flower and a flower bud.

45. The plant of claim 43, wherein the plant is selected from the group consisting of vegetable or fruit plants, grain plants and ornamental plants.

46. The plant of claim 45, wherein the vegetable or fruit plants are selected from the group consisting of tobacco, grape, strawberry, tomato, bell tomato, cucumber, potato, radish, cabbage, bean sprout, red pepper and spinach; wherein the grain plants are selected from the group consisting of rice, barley, corn, millet, bean and wheat; and wherein the ornamental plants are selected from the group consisting of chrysanthemum, rose, lily and gerbera.

47. The plant of claim 43, wherein “m” is from about 8 to about 23.

48. The plant of claim 43, wherein “m” is from about 10 to about 18.

49. The plant of claim 43, wherein X is hydroxyl or acetyloxy.

50. The plant of claim 43, wherein the compound is on the outer surface along with at least one non-Formula I substance.

51. The plant of claim 50, wherein the non-Formula I substance comprises at least one of an emulsifier and water.

52. The plant of claim 43, wherein the compound on the outer surface is in a scientifically traceable amount.

53. The plant of claim 43, wherein the compound is in an amount from about 0.00 μg/cm² to about 10 μg/cm².

54. The plant of claim 43, wherein the compound is in an amount from about 0.01 μg/cm² to about 10 μg/cm².

55. A method of producing the chemical-compound-treated plant of claim 43, the method comprising:
providing the plant body comprising the outer surface; and
contacting the outer surface with at least one of the compounds of Formula 1.

56. The method of claim 55, wherein the compound is contacted with the plant body in the form of liquid.

57. The method of claim 55, wherein the compound is contacted with the plant body in the form of powder.

58. The method of claim 55, wherein the compound is contacted with the plant body along with at least one non-Formula I substance.

59. The method of claim 58, wherein the non-Formula I substance comprises at least one of an emulsifier and water.

60. The method of claim 58, wherein the compound contacting the plant body has a concentration from about 0.01 ppm to about 1000 ppm.

61. The method of claim 58, wherein the compound contacting the plant body has a concentration from about 1 ppm to about 100 ppm.

62. The method of claim 55, wherein the compound is contacted with the plant body by sprinkling liquid or powder comprising the compound over the plant body.

63. The method of claim 55, wherein the compound is contacted with the plant body by immersing at least part of the plant body in a liquid comprising the compound.

64. The method of claim 55, wherein the plant body is contacted with the compound one or more times during a life thereof.

65. The method of claim 55, wherein the plant body is contacted with the compound sporadically or periodically.

66. The method of claim 55, further comprising maintaining the plant body in a condition sufficient to grow the plant.

67. A polyprenol treated plant, comprising:
a body of a plant, the body comprising an outer surface; and
polyprenol on the outer surface:

68. The plant of claim 67, wherein the polyprenol is represented by Formula II: 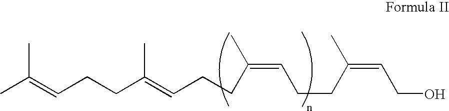
wherein “n” is an integer from 0 to about 30.

69. The plant of claim 68, wherein “n” is from about 5 to about 20.

70. The plant of claim 68, wherein “n” is from about 7 to about 15.

71. The plant of claim 68, wherein “n” is 8, 9 or 15.

72. The plant of claim 68, wherein the polyprenol comprises one or more different forms thereof, and wherein the different forms of the polyprenol have different “n”.

73. The plant of claim 68, wherein the plant body is one or more selected from the group consisting of a seed, a shoot, a root, a leaf, a bulb, a fruit, a stem, a trunk, a stalk, a cane, a flower and a flower bud.

74. A plant growth regulator for increasing crop yield of a plant, the regulator comprising a compound represented by Formula II below: 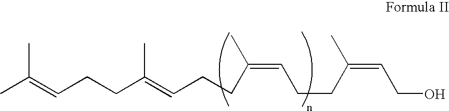
wherein “n” is 0 or a positive integer.

75. The plant growth regulator according to claim 74, wherein “n” is 8 or 9.

76. The plant growth regulator according to claim 74, wherein the plant is selected from the group consisting of vegetable or fruit plants, cereal plants, and flowing plants.

77. The plant growth regulator according to claim 76, wherein the vegetable or fruit plants are selected from the group consisting of tobacco, grape, strawberry, tomato, bell tomato, cucumber, potato, radish, cabbage, bean sprout, red pepper and spinach; wherein the cereal plants are selected from the group consisting of rice, barley, corn, millet, bean and wheat; and wherein flowering plants are selected from the group consisting of chrysanthemum, rose, lily and gerbera.

78. The plant growth regulator according to claim 74, further comprising an emulsifier.

79. The plant growth regulator according to claim 79, wherein the emulsifier comprises one or more selected from the group consisting octylphenol, polyoxyethylene, polyethyleneglycol fatty acid esters, ethylene glycol fatty acid esters, glycerol fatty acid esters, sucrose fatty acid esters, propylene glycol fatty acid esters, and sorbitan fatty acid or sorbitan fatty acid ester.

80. A method of growing a plant, comprising:
providing a plant; and
applying the plant growth regulator according to claim 74 to a seed of a plant or a portion thereof.

81. The method according to claim 80, wherein the plant growth regulator is applied by immersing the seed in a liquid comprising the plant growth regulator.

82. The method according to claim 80, wherein the plant growth regulator is applied by spraying the plant growth regulator onto the seed of the plant or the portion thereof.

83. The method according to claim 80, wherein the portion of the plant is one or more selected from the group consisting of a shoot, a root, a leaf, a bulb, a fruit, a stem, a trunk, a stalk, a cane, a flower and a flower bud.

84. The method according to claim 80, wherein the plant growth regulator is applied with a concentration of the compound at from about 0.01 ppm to about 1000 ppm.

85. A method of obtaining polyprenol, comprising:
providing part of a plant;
mixing the plant part with an organic solvent;
extracting organic substances from the plant part into the organic solvent, the organic substances comprising a polyprenol derivative; and
transforming the derivative to the polyprenol in the presence of a base and a reducing agent.

86. The method of claim 85, wherein the reducing agent comprises pyrogallol.

87. The method of claim 85, wherein the derivative is acetylated polyprenol.

88. The method of claim 87, wherein the step of transforming comprises hydrolyzing the acetylated polyprenol.

89. The method of claim 85, further comprising isolating the polyprenol.

90. The method of claim 85, wherein the polyprenol comprises one or more different forms having different numbers of a repeated unit thereof.

91. The method of claim 85, further comprising powdering the isolated polyprenol.

92. The method of claim 85, wherein the plant is selected from the group consisting of a cotton plant, a horse chestnut plant, a tobacco plant, a lords and ladies plant, a silver birch plant, a gingko plant and a soybean plant.

93. The method of claim 85, wherein the organic solvent is selected from the group consisting of ethanol, methanol, benzene and a mixture of one or more of the foregoings.
